(19) United States
(12) Patent Application Publication
(10) Pub. No.: US 2024/0375574 A1
(43) Pub. Date: Nov. 14, 2024

(54) VEHICLE TRANSPORT AND STORAGE SYSTEM AND METHODS OF USE

(71) Applicant: Jack Cooper Investments, Inc., Kennesaw, GA (US)

(72) Inventors: Michael Morvilius, Kennesaw, GA (US); Jason Bender, Kennesaw, GA (US)

(21) Appl. No.: 18/657,359

(22) Filed: May 7, 2024

Related U.S. Application Data
(60) Provisional application No. 63/501,041, filed on May 9, 2023.

(51) Int. Cl. B60P 3/077

(52) U.S. Cl. CPC B60P 3/077

(57) ABSTRACT

A self-contained, mechanized automobile transport system used to load, secure, transport, and unload units for vehicle shipments on ships, on rail cars, on semi-truck trailers, or any other shipping method. The system may include a rack affixed to the floor of a container, a ramp, a ramp adapter, one or more winch mount assemblies, one or more trolleys, one or more winches, and a power source for providing power to the one or more winches via an electrical system. A vehicle may be loaded and secured onto one or more trolleys, and the one or more winches pulls the first vehicle into the container. The trolleys interact with the winch mount assemblies to secure the vehicle in the container.

### CROSS REFERENCE TO RELATED APPLICATIONS

The present application claims priority under 35 U.S.C. § 119 to U.S. Provisional Application No. 63/501,041, entitled “VEHICLE STORAGE SYSTEM AND METHODS OF USE THEREOF,” and filed on May 9, 2023, the entire content of which is incorporated by reference.

### TECHNICAL FIELD

This present disclosure relates generally to vehicle storage and transportation systems and methods of use, and more particularly, to vehicle storage systems within a transportable container.

### BACKGROUND

In 2020, the United States exported about two million vehicles and imported about 6.5 million vehicles, and many of these vehicles were shipped in shipping containers via ships, trains, or semi-trailer trucks. The various conventional vehicle shipping systems and methods utilizing shipping containers generally have many flaws or disadvantages. For example, several shipping methods require the shipping container to be modified on the outside, such as cutting doors into the container, so that a driver can drive the vehicle into the container and have enough room to open the vehicle door to exit the vehicle. Other vehicle shipping systems utilized raised racks, which lift a vehicle in the air within the container so that another vehicle can be put underneath, but these systems are incredibly dangerous to the people working with them, as the vehicles are prone to falling and the raised racks prone to failing, and the raised racks are not stable if the ship, train, or semi-trailer truck comes to a sudden stop, causing damage to the vehicles. Most conventional vehicle shipping systems and methods require workers to go into the container and tie down and secure each of the wheels of the vehicle, which can be dangerous and tedious. Additionally, conventional vehicle shipping systems and methods do not include any theft prevention system or countermeasures, apart from the door to the shipping container. Criminals can easily break open the container doors and steal the vehicles inside, or use the accessible vehicle to smuggle illicit goods or traffic humans.

Thus, there is a long-felt, but unresolved need for a vehicle storage system that can automatically transport and secure a vehicle inside a shipping container without an operator or driver inside the container while the vehicle is being transported, and further that provides increased theft prevention support by limiting or altogether preventing access to the vehicles while in a shipping container.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIGS. 1A-1J illustrate perspective, side, top, and back views of an example vehicle storage system, according to one embodiment of the present disclosure;

FIGS. 2A-2C illustrate perspective and side views of an example vehicle storage system loading a second vehicle, according to one embodiment of the present disclosure;

FIGS. 2D-2F illustrate perspective and side views of an example ramp adapter, according to one embodiment of the present disclosure;

FIGS. 3A-3E illustrates perspective, top, and detail views of an example ramp and container, according to one embodiment of the present disclosure;

FIGS. 4A-4J perspective and side views of portions of an example ramp, according to one embodiment of the present disclosure;

FIGS. 5A-5H illustrate perspective views of an example ramp in various stages of unfolding, according to one embodiment of the present disclosure;

FIGS. 6A-6F illustrate perspective, side, top, and detailed views of the rack, according to one embodiment of the present disclosure;

FIGS. 7A-7D illustrate perspective, top, and side views of an example trolley, according to one embodiment of the present disclosure;

FIGS. 8A-8C illustrate perspective, top, and side views of an example winch mount assembly, according to one embodiment of the present disclosure;

FIGS. 9A-9E illustrate side, top, and perspective views of an example trolley interacting with an example winch mount assembly, according to one embodiment of the present disclosure;

FIGS. 9F-9G illustrate side views of an example vehicle in an example system, according to one embodiment of the present disclosure; and

FIGS. 10A-10B are flowcharts that illustrate an exemplary method for loading and unloading multiple vehicles inside a trailer using an exemplary system, according to one embodiment of the present disclosure.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes exemplary systems, methods, and apparatuses that embody various elements of the present disclosure. However, it should be understood that the described disclosure may be practiced in a variety of forms in addition to those described herein.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

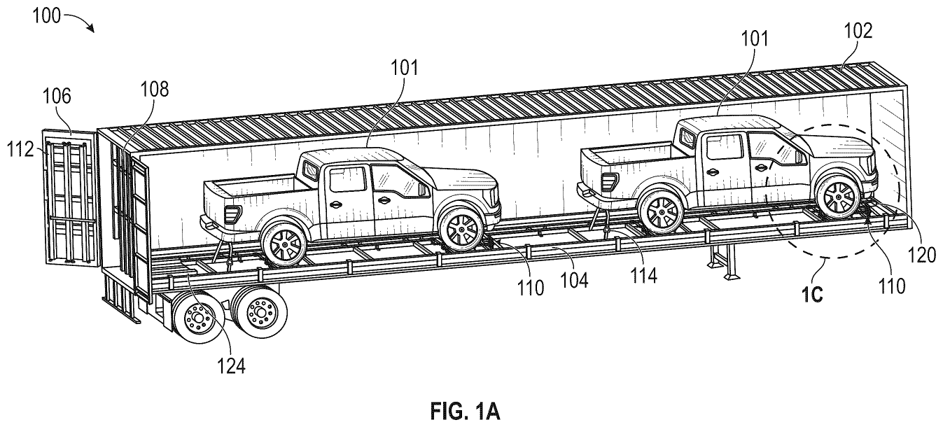

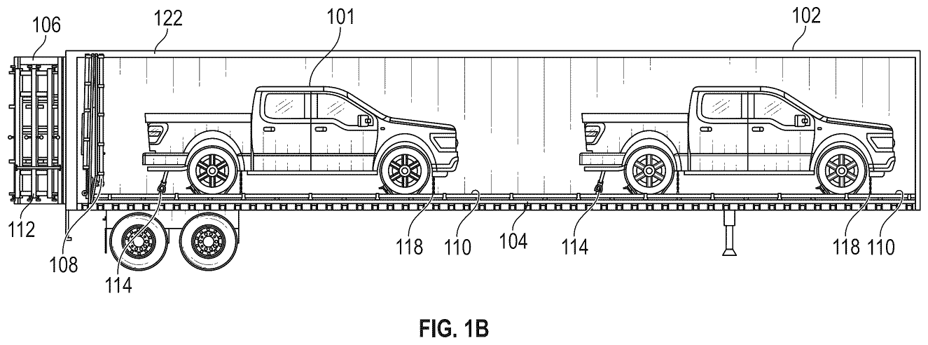

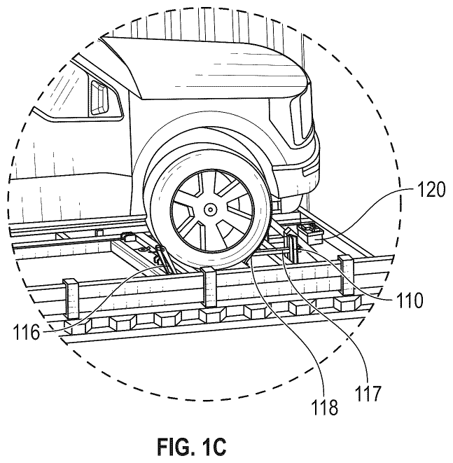

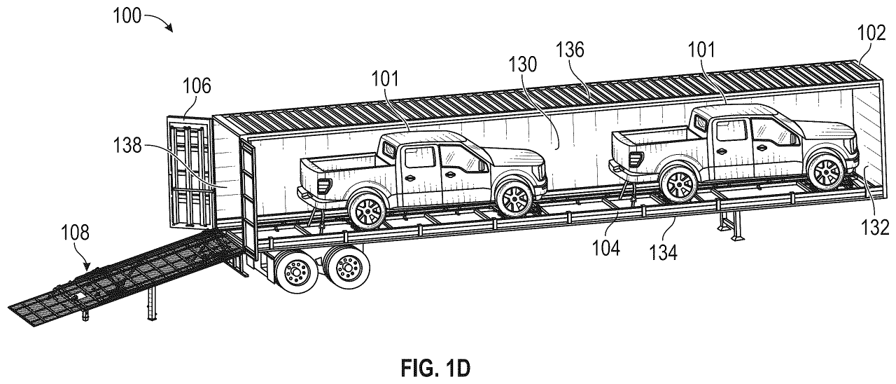

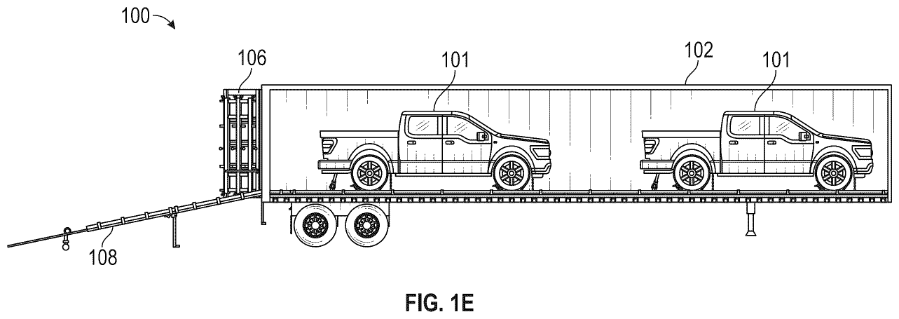

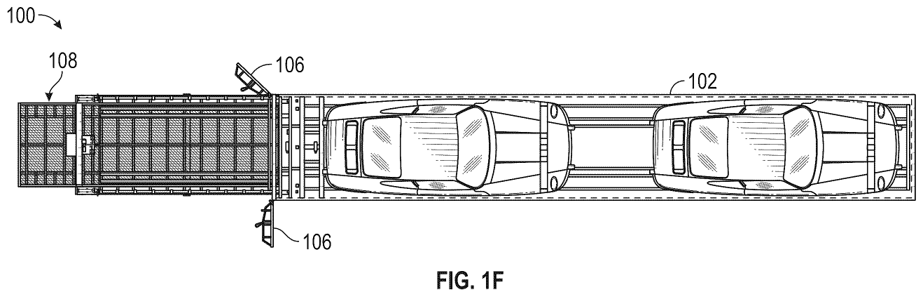

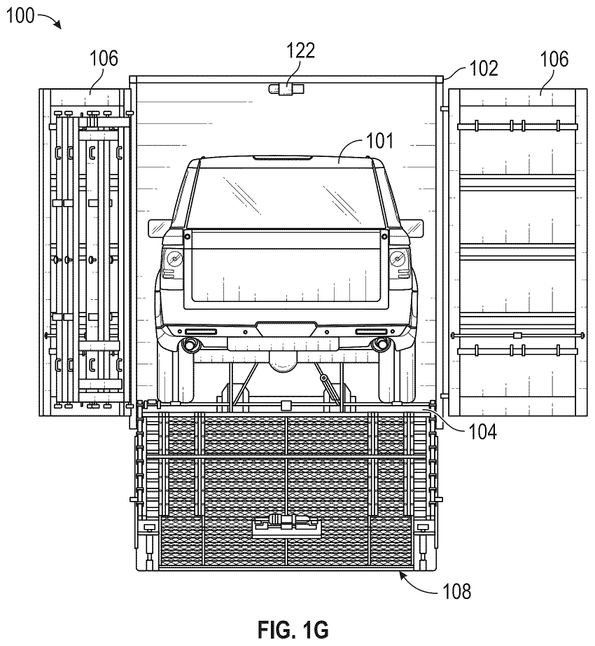

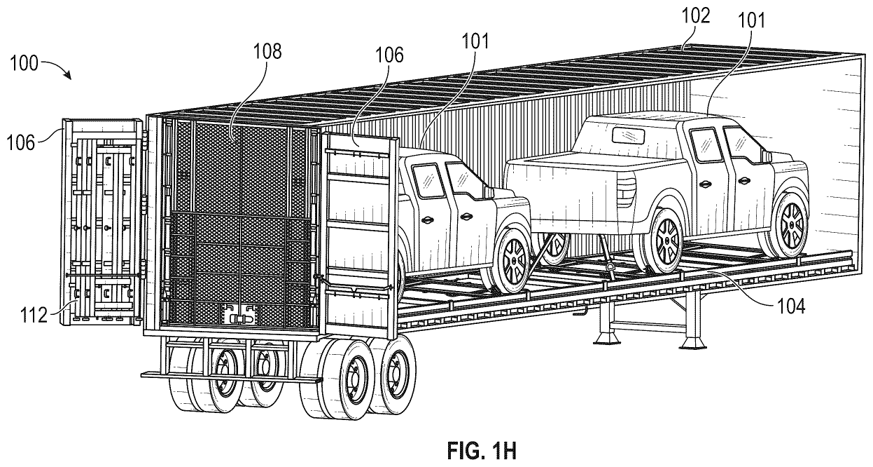

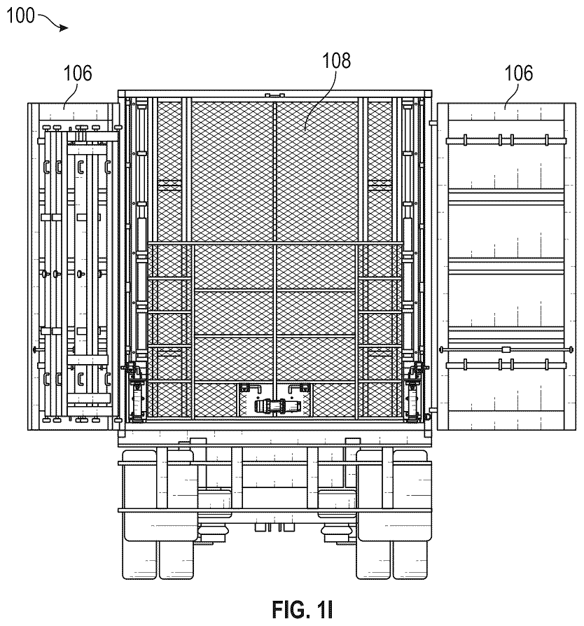

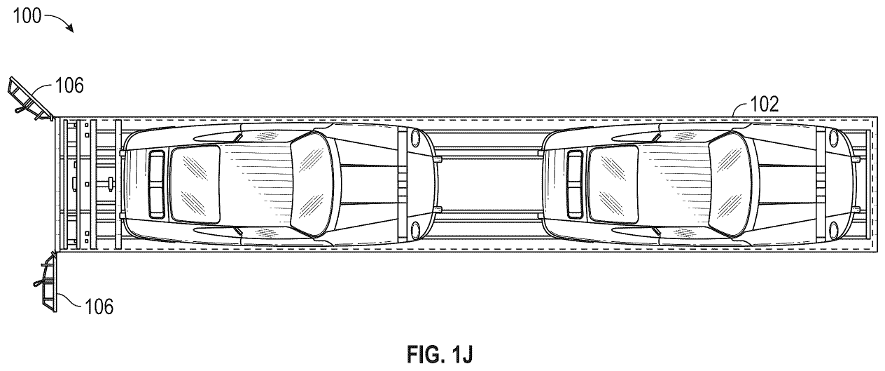

Referring now to the figures, for the purposes of example and explanation of the fundamental processes and components of the disclosed systems and methods, reference is made to FIG. 1, which illustrates an example embodiment of a self-contained, mechanized automobile transport system 100 used to load, secure, transport, and unload units. The system 100 is an example of a storage system for storing vehicles in containers for shipping and storage purposes, as described in greater detail below. As will be understood and appreciated, the example shown in FIG. 1 represents merely one container in which an exemplary vehicle storage system may be utilized. It will be understood that the vehicle storage system as described herein may be used in and with substantially any other container capable of fitting a vehicle.

Turning to FIGS. 1A-1J show various perspective, side, top, and back views of an example system 100 storing two vehicles 101 within a container 102. However, as further discussed herein, the system 100 may store one vehicle, two vehicles, three vehicles, or more than three vehicles, depending on the size of the container and the size of the vehicles, for storage or shipping purposes. The system 100 may be utilized for vehicle shipments overseas (on ships), on rail cars, on semi-truck trailers, or any other shipping method. The container 102 may be a standard shipping container, or any other size of container or trailer that can hold at least one vehicle inside. The container 102 further has a door 106, which may be a bi-fold door or any other door. The door 106 may include components for storing one or more trolleys 112. The system 100 may be a self-contained unit that fits any size container 102, and the system 100 can be removed from a first container 102 and be redeployed in a second container 102. Additionally, because multiple vehicles 101 may be shipped in the same container 102, carbon emissions are reduced as compared to conventional vehicle shipping systems.

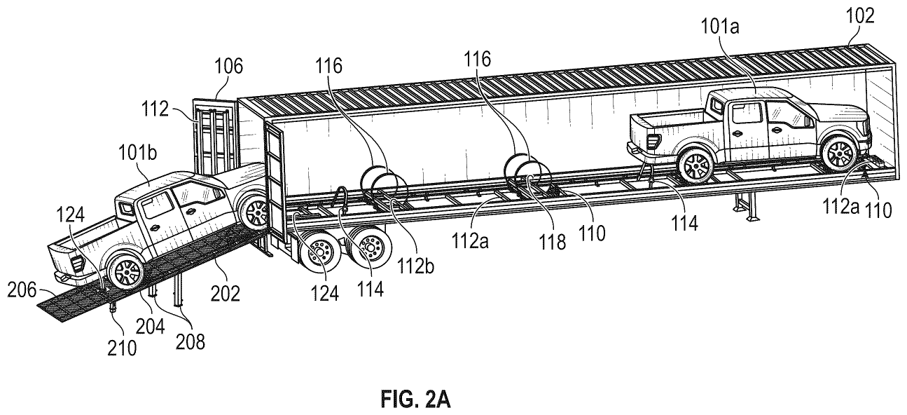

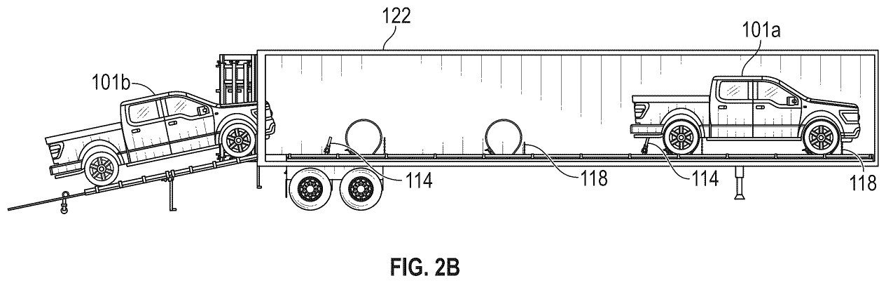

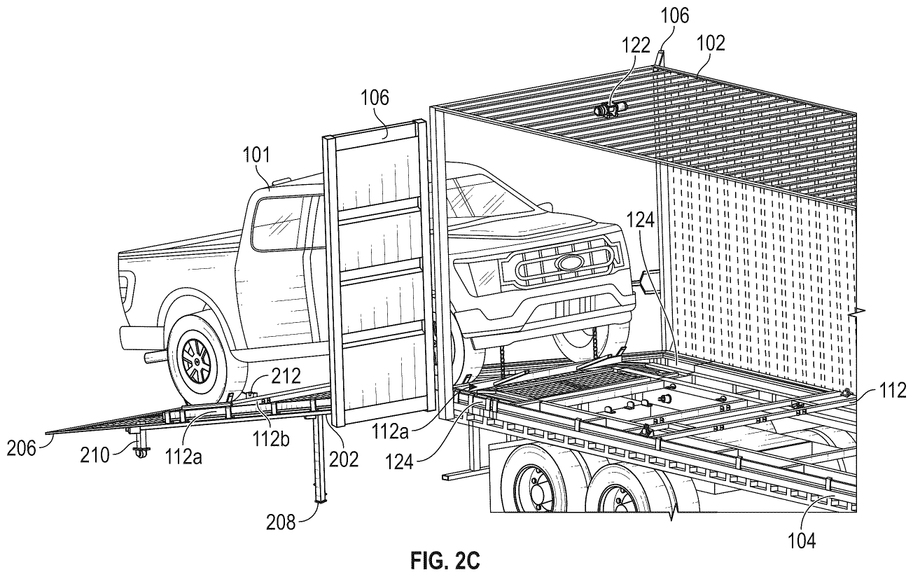

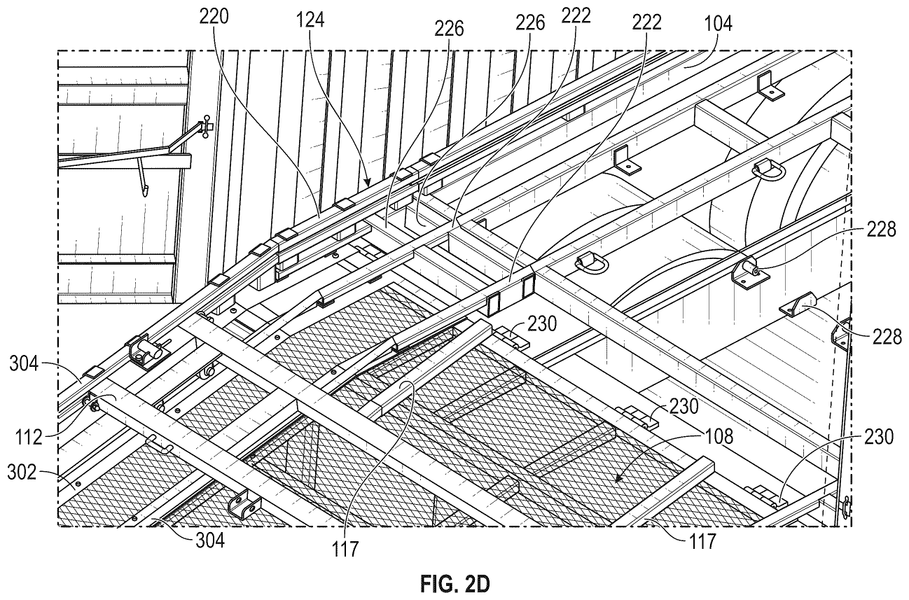

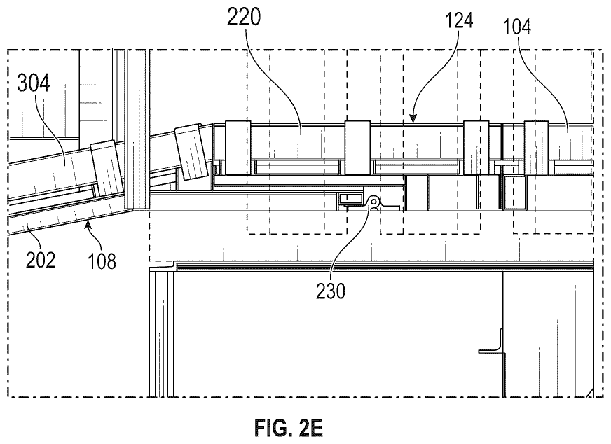

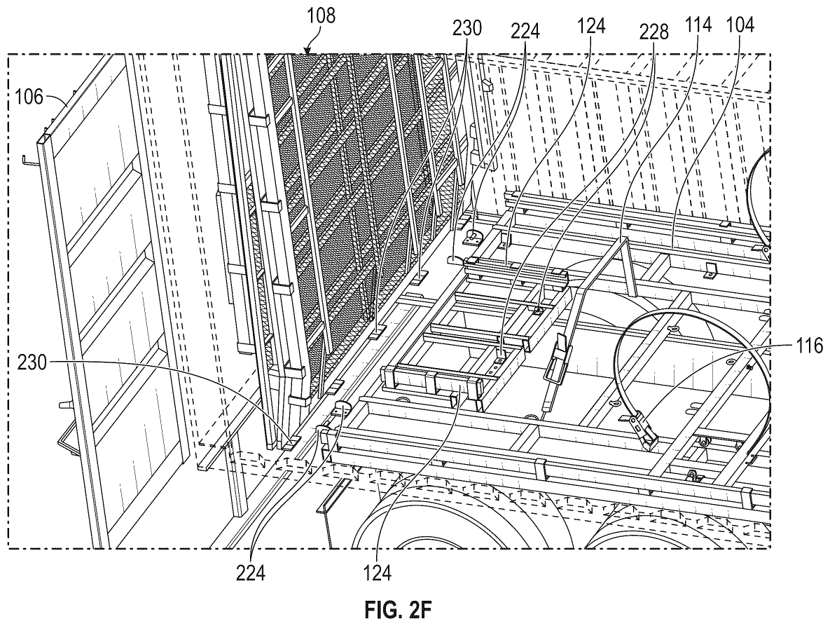

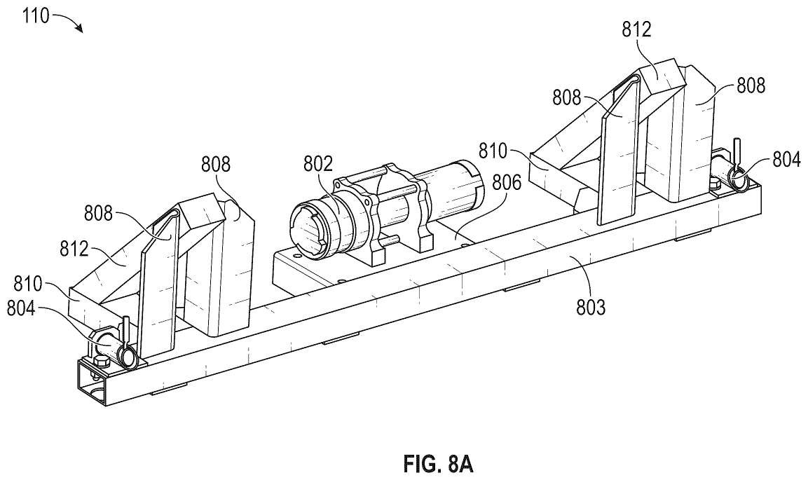

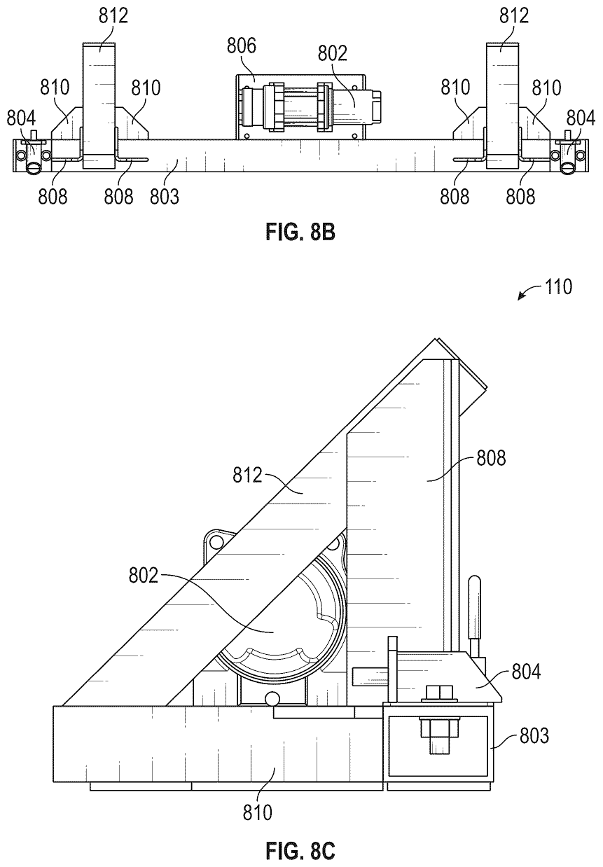

The system 100 may include a rack 104, a ramp 108, a ramp adapter 124, one or more winch mount assemblies 110, one or more trolleys 112, one or more winches (i.e., rear winch 122, ramp winch 212 as shown in FIGS. 2A-2C, and/or one or more mounted winches 802 as shown in FIGS. 8A-8C), and a power source 120 for providing power to the one or more winches via an electrical system. The system 100 may further include one or more switches for turning the one or more winches on and off. The ramp adapter 124 is a removable portion of the rack 104 that connects tracks of the ramp 108 to tracks of the rack 104, as shown in FIGS. 2D-2F, so that the trolleys 112 can be moved up the ramp 108 and onto the rack 104 to facilitate the loading of the one or more vehicles 101.

In multiple embodiments, a vehicle 101 may be loaded onto a first trolley 112a and a second trolley 112b of the one or more trolleys 112 on the ramp 108, whereby the front wheels of the vehicle 101 are on the first trolley 112a and the back wheels of the vehicle 101 are on the second trolley 112b (though the vehicle 101 may also be loaded in reverse, such that the back wheels are in the first trolley 112a and the front wheels are in the second trolley 112b) (as shown in FIG. 2). The vehicle 101 is loaded onto the one or more trolleys 112 by a driver (an autonomous driver, human, or remotely by a human), and after the vehicle 101 is loaded on the trolleys 112, the driver exits the vehicle. In many embodiments, each wheel of the vehicle 101 is then strapped to the respective trolley 112a or 112b by a wheel tie-down ratchet strap 116. In many embodiments, the wheel tie-down ratchet strap 116 has a first end and a second end, and the strap 116 is looped around the wheel and is connected to the trolley 112 (as shown in FIG. 1C). Additionally, one or more front bars 117 (as shown in FIG. 1C) are connected to the first trolley 112a. At least one front bar tie down chain 118 is connected at a first end to each of the one or more front bars 117, and once the vehicle 101 is loaded on the first trolley 112a, the at least one front bar tie down chain 118 is connected at a second end to the undercarriage of the vehicle 101, which, when the first trolley 112a is in the final storage position, operates to further secure the vehicle 101 in order to prevent the vehicle 101 from moving during shipping.

Once the vehicle 101 is loaded onto the one or more trolleys 112 and the wheels are strapped onto the one or more trolleys 112, the first trolley 112a is connected to an end of a cord of a mounted winch 802 (as shown in more detail in FIGS. 8A-8C) that is connected to a first winch mount assembly 110a of the one or more winch mount assemblies 110. An operator may turn the mounted winch 802 on with a switch near the door 106 of the container 102 so that the operator does not have to enter the container 102, which may prevent injuries to the operator that can occur if the operator is in the container 102 while the vehicle 101 is being moved by the system 100. Thus, loading and unloading of the vehicle 101 on the trolleys 112 occurs on the ground and ramp 108, so that no operator is in the container 102 or vehicle 101 while the vehicle is being pulled into or out of the container 102. The mounted winch 802 pulls the first trolley 112a, and thus, the vehicle 101 and second trolley 112b, up the ramp 108 and into the container 102 via the ramp adapter 124 and the rack 104. In at least one embodiment, the electrical system of the system 100 may be configured so that when the operator turns the mounted winch 802 on so that it is pulling a vehicle 101 into the container 102, the ramp winch 212 may be turned on in a reverse position so that the cord connected with the ramp winch 212 is unwound.

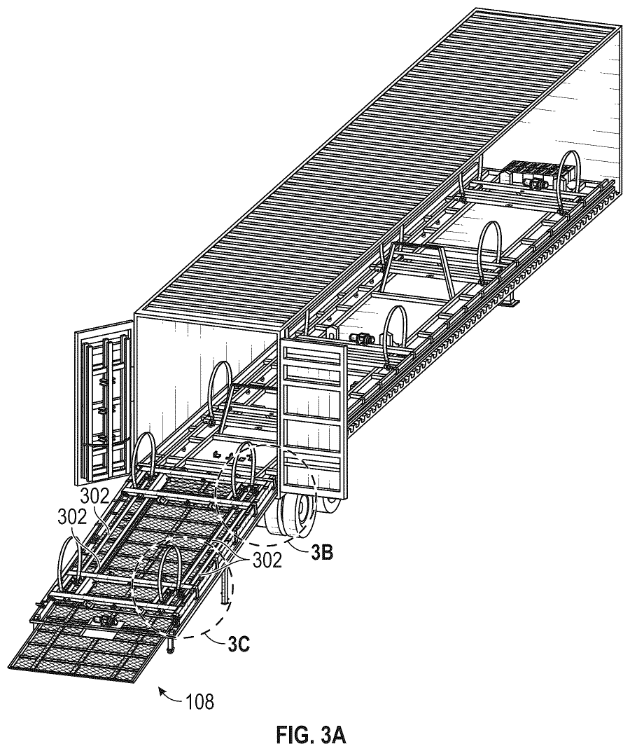

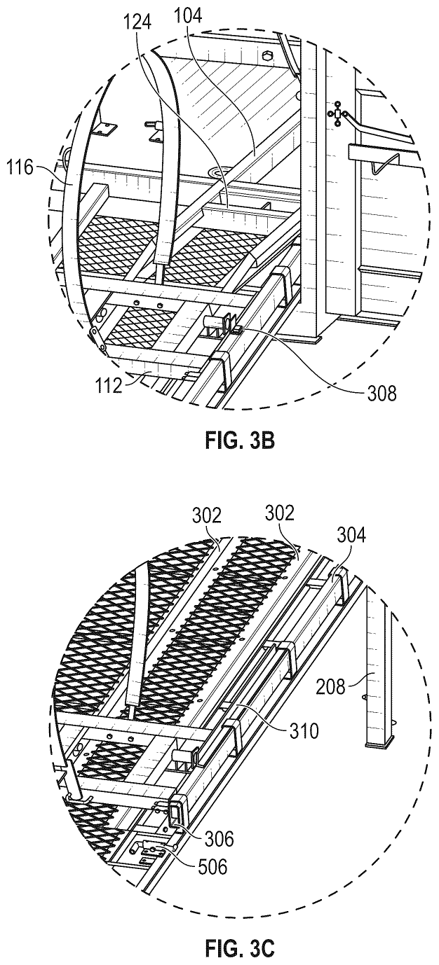

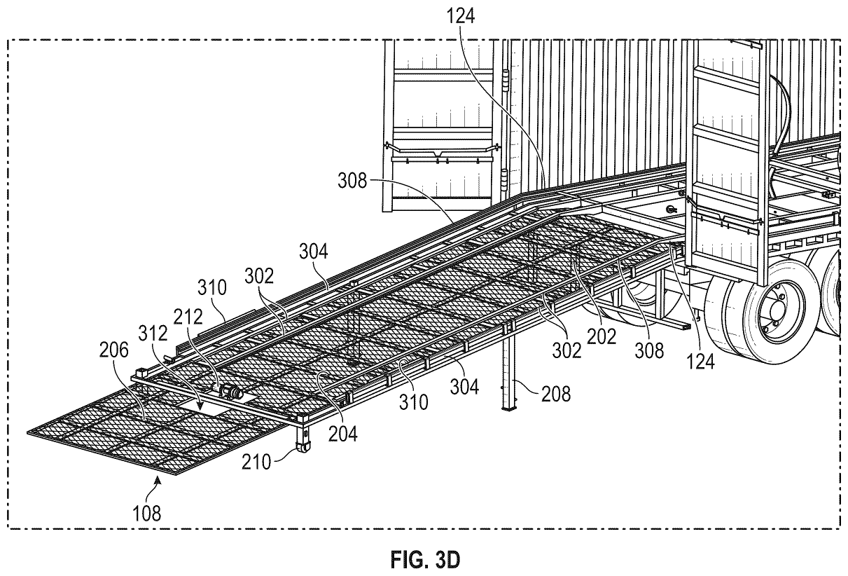

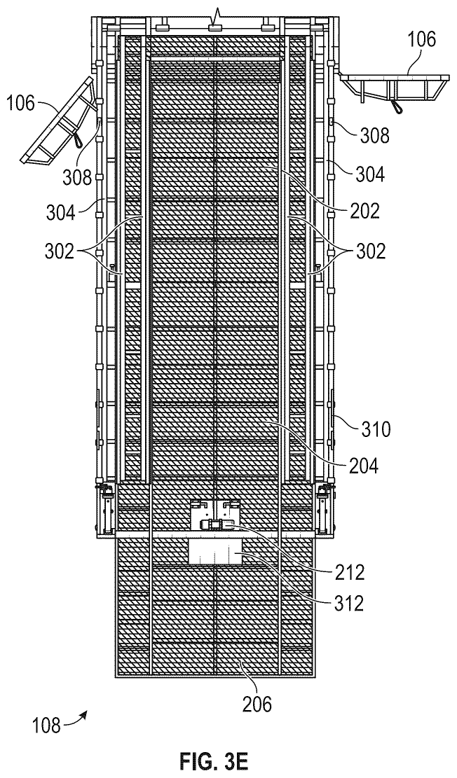

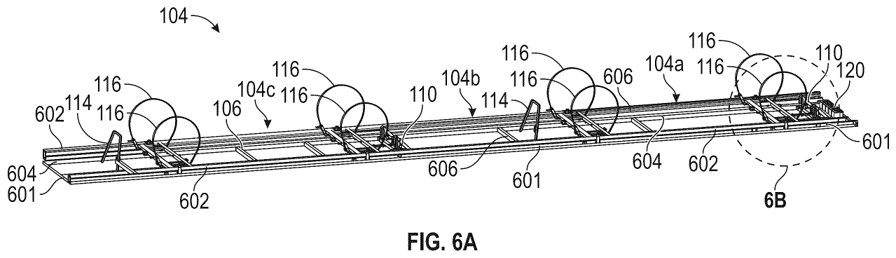

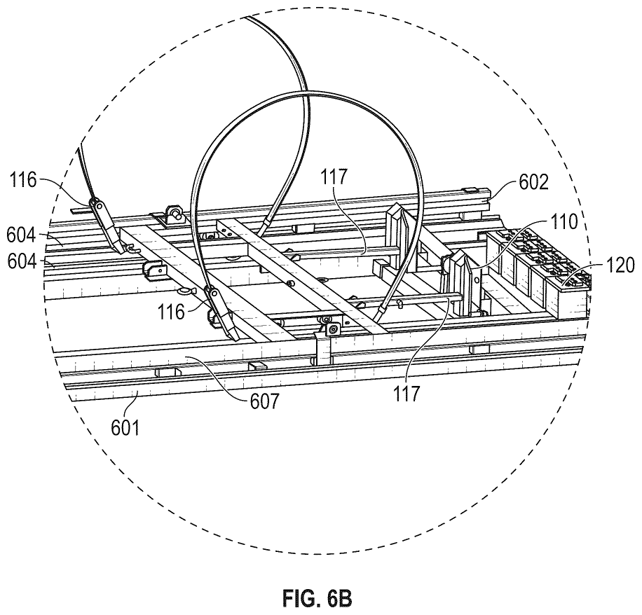

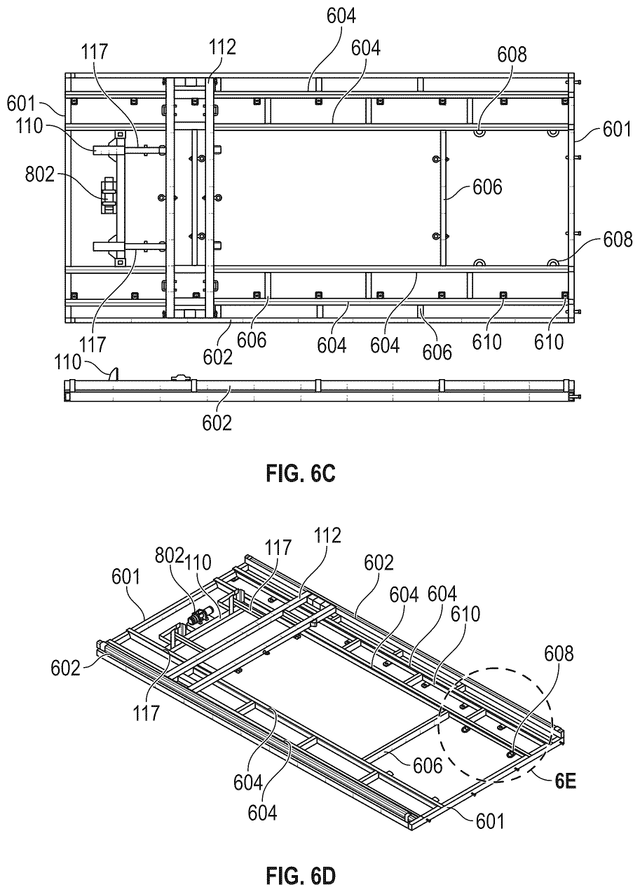

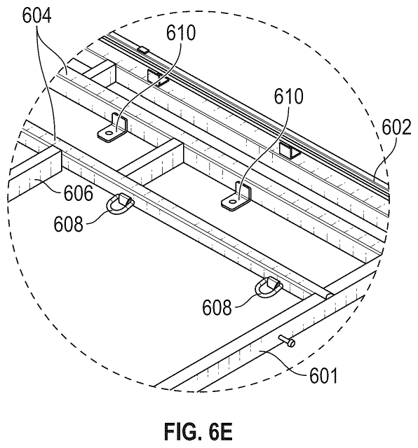

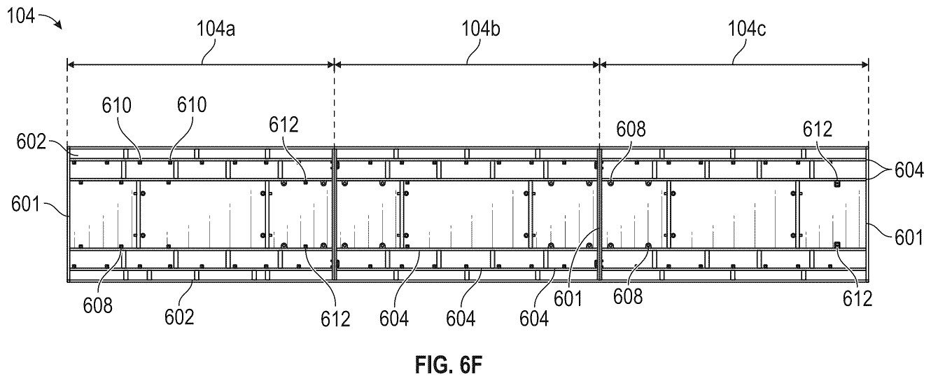

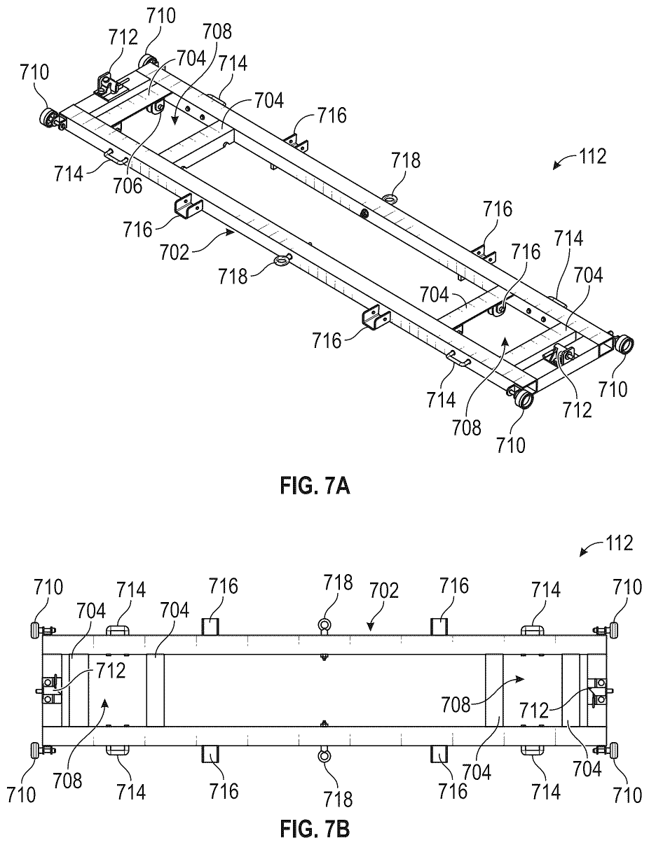

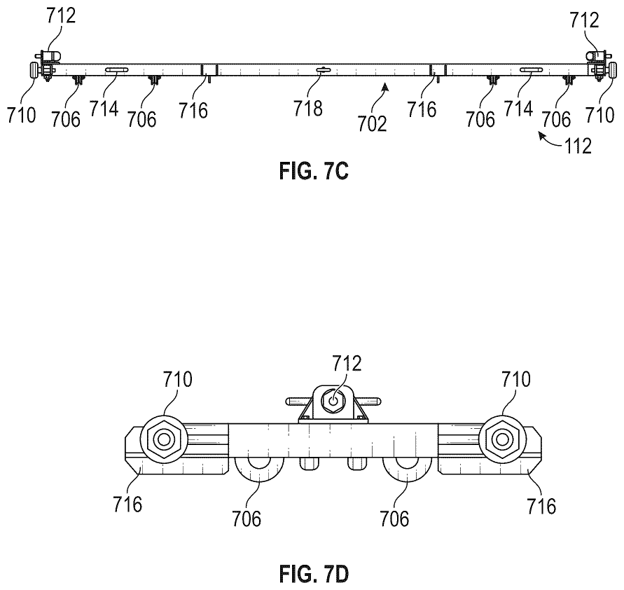

In many embodiments, the one or more trolleys 112 include one or more trolley casters 706 (as shown in FIGS. 7A-7D) that roll on the tracks (ramp caster tracks 302 as shown in FIGS. 3A-3E) of the ramp 108, tracks (adapter caster tracks 222 as shown in FIG. 2D) of the ramp adapter 124, and tracks (rack caster tracks 604 as shown in FIGS. 6A-6F) of the rack 104 when being pulled by the mounted winch 802. The ramp caster tracks 302 of the ramp 108, the adapter caster tracks 222 of the ramp adapter 124, and the rack caster tracks 604 of the rack 104 may be aligned so that the trolleys 112, when being moved from the ramp 108 to the final position on the rack 104, can transition between the components without becoming stuck or otherwise failing. In several embodiments, the mounted winch 802 may pull the first trolley 112a until the front bar 117 contacts and interacts with the first winch mounting assembly 110a (as shown in FIGS. 8A-8C), causing the vehicle 101 to be in the final storage position. In some embodiments, an operator may then connect the rear of the vehicle 101 to the rack 104 with one or more rear tie-down ratchet straps 114. The one or more rear tie-down ratchet straps 114 may be a ratchet strap and include a first and a second end, where the first end is connected to the rack 104 (at a D-ring tie down 608 as shown in FIGS. 6A-6F), and the second end is passed through a part of the rear of the vehicle 101 and connected to the rack 104, and then tightened to better secure the rear of the vehicle 101 to prevent the vehicle from moving during shipping. In many embodiments, the first end and second end of the rear tie-down ratchet strap 114 may include connection devices, such as hooks or other similar connection devices, so to connect with the rack 104.

In many embodiments, if more than one vehicle 101 is being loaded into the container 102 with the system 100, a second winch mount assembly 110b may be connected to the rack 104 behind the loaded first vehicle 101, and the second vehicle 101 may be loaded into the container 102 in the same method as described above utilizing the second winch mount assembly 110b.

Once the one or more vehicles 101 are loaded into the container 102 with the system 100, the ramp adapter 124 is disconnected from the rack 104 and ramp 108 and stored in the container 102 as shown in FIG. 1A. The ramp 108 is raised by a rear winch 122 that is attached to the ceiling or a side wall of the inside of the container 102. As the ramp 108 is raised, it folds up so that it fits inside the container 102, and, once the ramp 108 is raised, the door 106 is closed and locked. In many embodiments, the ramp adapter 124 is removable so that the ramp 108 can be folded into the container 102, which, in some embodiments, may not be possible if the rack 104 extended to the end of the container 102. However, in other configurations of the system 100, the rack 104 extends to the end of the container 102 such that, when the ramp 108 is lowered, the ramp 108 connects directly with the rack 104.

The container 102 may be shipped on a train, on a boat, on a truck, or by any other method of shipping containers. To unload the vehicles 101, the door 106 is unlocked and the ramp 108 is lowered by the rear winch 122 and unfolded, and the ramp adapter 124 is connected to the ramp 108 and rack 104, and the one or more rear tie-down ratchet straps 114 are disconnected from the second vehicle 101. The ramp 108 may include a ramp winch 212 (as shown in FIG. 2) that is utilized to pull the vehicles 101 out of the container 102. In many embodiments, the ramp winch 212 is small enough or mounted in a specific way such that any vehicle can drive over the ramp winch 212 without contacting the ramp winch 212.

Specifically, a cord attached to the ramp winch 212 is attached at the opposite end to the second trolley 112b that the second vehicle 101 is loaded onto. An operator may turn the ramp winch 212 on, which pulls the second vehicle 101 across the rack 104, over the ramp adapter 124, and down the ramp 108. In many embodiments, the cord to the mounted winch 802 on the winch mount assembly 110 is not removed after the vehicle 101 is loaded into the container 102, so when the ramp winch 212 is turned on, the mounted winch 802 on the winch mount assembly 110 is turned on in a reverse position such that the cord attached to the mounted winch 802 can be pulled from the mounted winch 802 to allow the vehicle 101 to be taken out of the container 102. However, in some embodiments, the mounted winch 802 may provide a counter force against the ramp winch 212 and vehicle 101 as the trolleys 112 are pulled down the ramp 108, so that the vehicle is lowered down the ramp 108 in a controlled manner and no damage is caused to the vehicle 101 or system 100. The one or more wheel tie-down ratchet straps 116 and the one or more front bar tie down chains 118 are disconnected, as well as the cord connected to the ramp winch 212 and the cord connected to the mounted winch 802, and an operator may thereafter drive or otherwise move the vehicle off the ramp 108. Thereafter, the operator may remove the winch mount assembly 110b, and attach the cord connected to the ramp winch 212 to the second trolley 112 that the first vehicle 101 is loaded on, and remove the one or more rear tie-down ratchet straps 114 from the first vehicle 101, and the ramp winch 212 may pull the second trolley 112b, and thus, the first vehicle 101 and first trolley 112a across the rack 104 and ramp adapter 124, and down the ramp 108, where the first vehicle 101 is removed in the same way as the second vehicle 101.

In several embodiments, as shown in FIG. 1A, two vehicles 101 are stored in the container 102 by the system 100. In many embodiments, the rack 104 is shown having two sections, one section for each vehicle 101. The rack 104 is connected to the floor of the container 102, and may be connected by bolting, or any other connection device or method. As shown in FIG. 1A, each vehicle 101 has a winch mount assembly 110 in front of it, and each vehicle 101 has two rear tie-down ratchet straps 114 connected to the rear of the vehicle and the rack 104.

As shown in FIG. 1C, the power source 120 is located at the front of the container 102. The power source 120, as shown in FIG. 1C, may be one or more batteries, or may be a generator or engine or any other power source that can provide power to the one or more winches. In at least one embodiment, the power source 120 may be lithium ion marine batteries with 100 pounds of thrust for seven days straight, may last for 1000 cycles, and may be replaced every 2-3 years. In some embodiments, the power source 120 may also be connected to an electrical system such that an operator can turn one or more winches (e.g., the mounted winch 802, the ramp winch 212, the rear winch 122) on or off, or in a reversible configuration such that the cord connected to the said winch is unwound from the winch. In at least one embodiment, the one or more mounted winches 802 may be in an off or reversible configuration when the ramp winch 212 is in operation and pulling one of the vehicles 101 out of the container 102, since the cord of the mounted winch 802 is not disconnected from the first trolley 112a once the first trolley 112a is in the final loaded position (i.e., the vehicle is loaded and secured).

In several embodiments, the electrical system may run along a sidewall 130 of the container 102 from the power source 120 to the switch at the container opening. In many embodiments, each of the ramp winch 212, rear winch 122, and mounted winches 802a and 802b may be connected to the electrical system in order to be turned on or off. In some embodiments, the ramp winch 212, rear winch 122, and mounted winches 802a and 802b may be connected in series to the electrical system. In other embodiments, each winch of the aforementioned winches may be connected in parallel to the electrical system so that each may be selectively powered on and off by the operator. Still, in another embodiment, the rear winch 122 may be connected in parallel to the electrical system, and the ramp winch 212 and mounted winches 802a and 802b may be reversibly connected in series to the electrical system, so that when the ramp winch 212 is pulling a vehicle out of the container 102, the mounted winch 802a or mounted winch 802b are in a reversed configuration such that the cords are unwinding from the mounted winch 802a or mounted winch 802b, and that the ramp winch 212 is in a reversible configuration when the mounted winches 802a or 802b are in a normal on position.

Additionally, as shown in FIGS. 1A-1J, the container 102 includes two side walls 130, an end wall 132, a floor 134, and a ceiling 136, and may define an opening 138 that is covered or substantially covered when the door 106 is closed. as well as the door 106 that, when closed, may cover or substantially cover an opening 136 in the container 102. Additionally, as shown in the figures, the container 102 is set on a chassis of a semi-trailer truck, though the container 102 could be set on a train car, a boat, or any other vehicle used for shipping that has the capacity to carry the container. In one or more embodiments, the container 102 may be a standard 53 foot stack container, but in other embodiments, the container 102 may be any other size container, such as, but not limited to, a 40 foot container or a 20 foot container, as long as the container 102 can support the system 100 and fit at least one vehicle 101 within the container 102.

Turning now to FIGS. 2A-2C, perspective and side views of an example system 100 loading a second vehicle 101 are shown, according to one embodiment of the present disclosure. As shown in FIGS. 2A and 2B, one vehicle 101a is loaded in the container 102 by the system 100. The front wheels of the vehicle 101a are strapped onto the first trolley 112a and the back wheels of the vehicle 101a are strapped onto the second trolley 112b by wheel tie-down rachet straps 116. Additionally, the rear of the vehicle 101a is further secured to the rack 104 via the rear tie-down ratchet strap 114 that is put through the undercarriage of the vehicle 101 and attached at either end to the rack 104.

In many embodiments, the rack 104 may be separated into functional sections, such as rack sections 104a, 104b, and 104c. The rack 104 and rack sections 104a, 104b, and 104c are more fully described in relation to FIGS. 6A-6F.

Further, FIG. 2A shows, in rack section 104b, the components of the system 100 that secure the vehicle 101 into place upon being loaded into the container 102, to more clearly show the components of the system 100. For example, FIG. 2A, in rack section 104b, shows the winch mount assembly 110, the two trolleys 112a and 112b, the rear tie-down ratchet strap 114, the wheel tie-down ratchet straps 116, and the front bar tie down chain 118. In some embodiments, the rack 104 may be connected to the ramp 108 by ramp adapters 124. The ramp adapters 124 operate as transition pieces so that the trolleys 112, with a vehicle 101 attached, can be pulled up the ramp 108 and onto the rack 104 without the trolley 112 lifting up from the ramp 108 or rack 104 due to the force of the vehicle on a lower portion of the trolley 112.

In various embodiments, as shown in FIGS. 2A-2C, the ramp 108 may include a top section 202, a middle section 204, and a bottom section 206, wherein each of the top section 202, middle section 204, and bottom section 206 may be made of a metal material or hard plastic material (e.g., aluminum, steel, other similar metals, PVC, etc.), such that the ramp 108 can hold the weight of a vehicle 101 as it is being loaded or unloaded. The ramp 108 may also include one or more top section support tubes 208 and one or more middle section support tubes 210, and may also include a ramp winch 212 on the middle section 204 of the ramp 108, though the ramp winch 212 may be placed anyone on the ramp 108 or container 102 so long as the ramp winch 212 can pull the vehicles 101 out of the container 102 during the unloading process. In a preferred embodiment, the ramp winch 212 is placed proximate to the middle of the ramp 108 so that the ramp winch 212 can pull the vehicles 101 straight back out of the container 102. However, in another embodiment, the system 100 may utilize two or more winches for unloading the vehicles, and the two or more winches may be proximate to the middle of the ramp 108, or may be on the side walls 132 of the container 102, such that the two or more winches utilize one or more pulleys to pull the vehicles 101 straight out of the container 102.

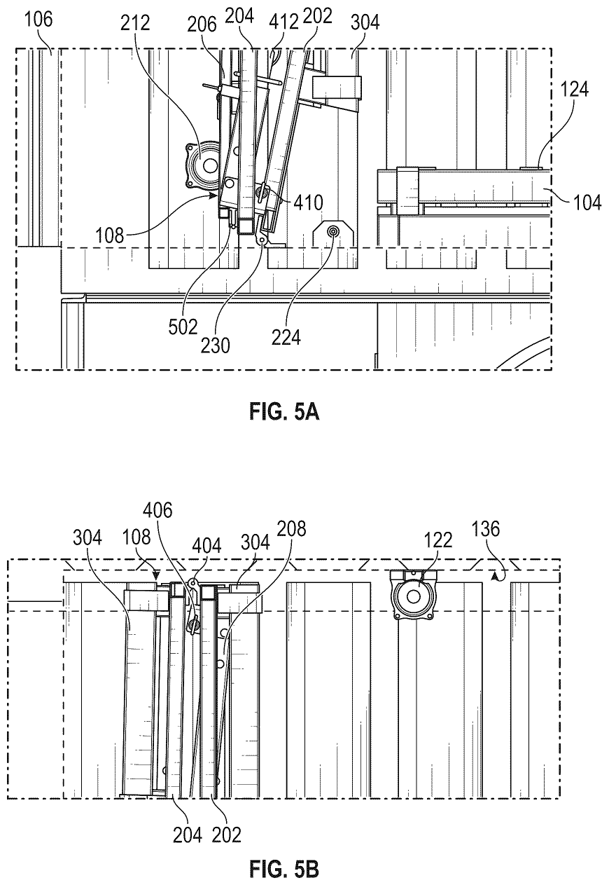

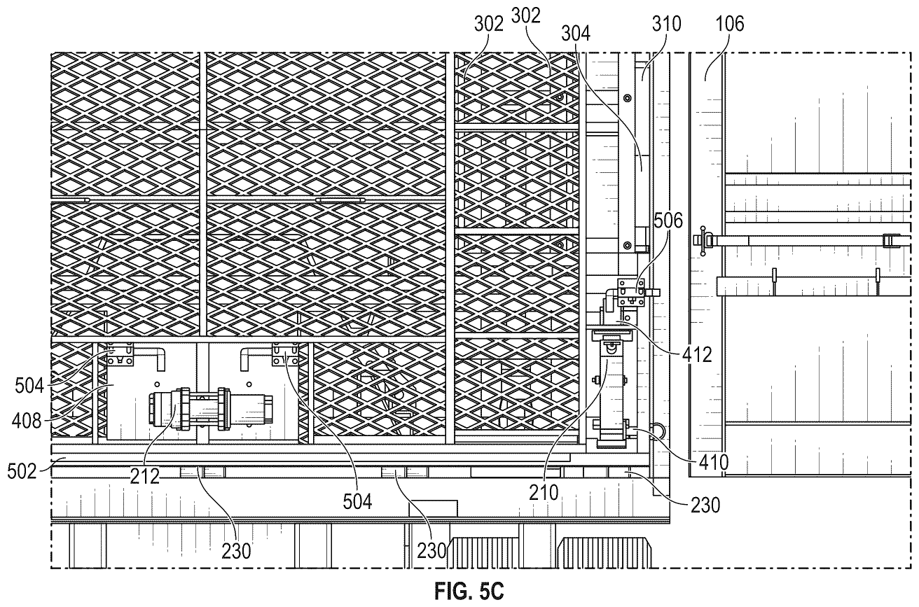

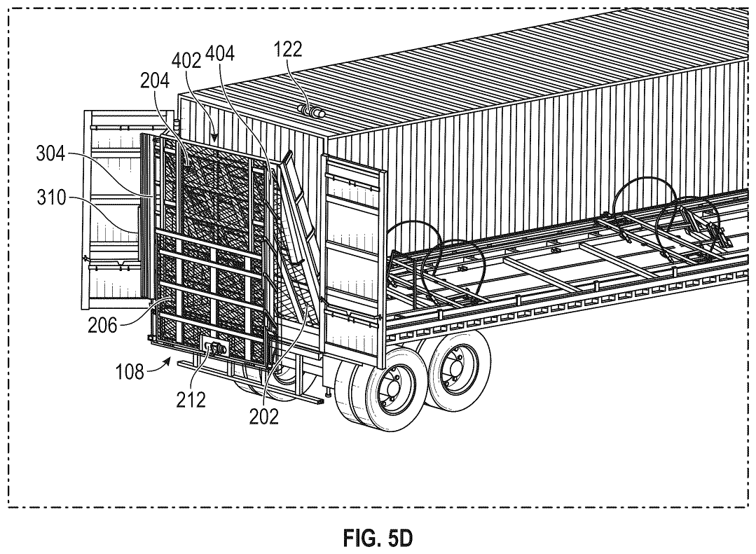

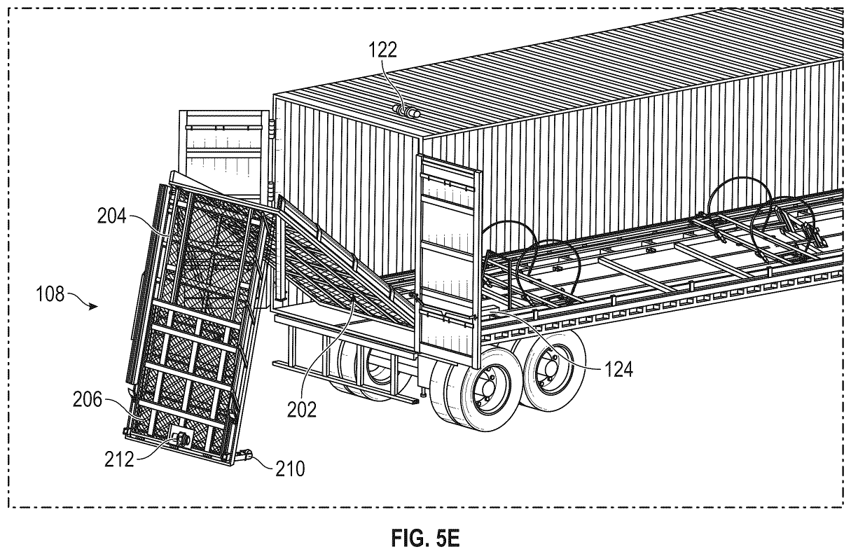

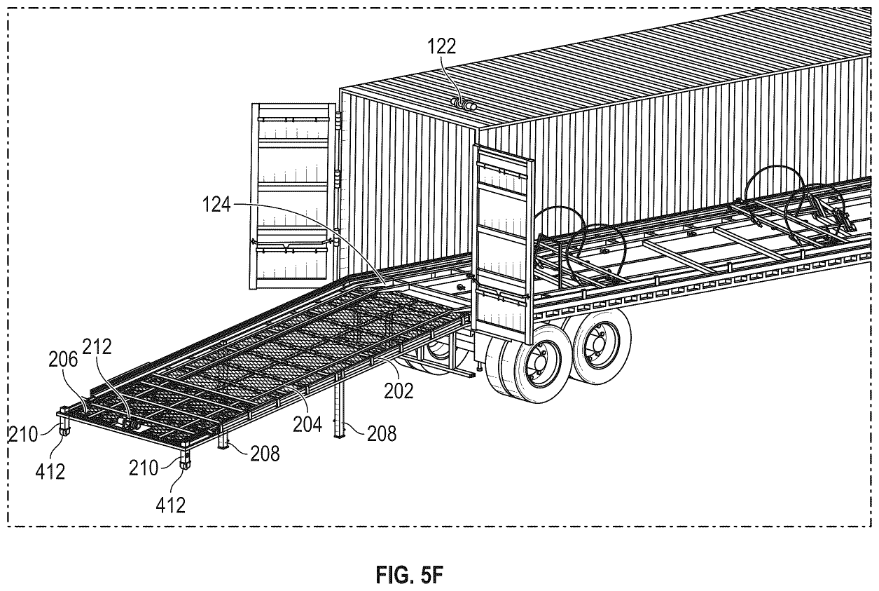

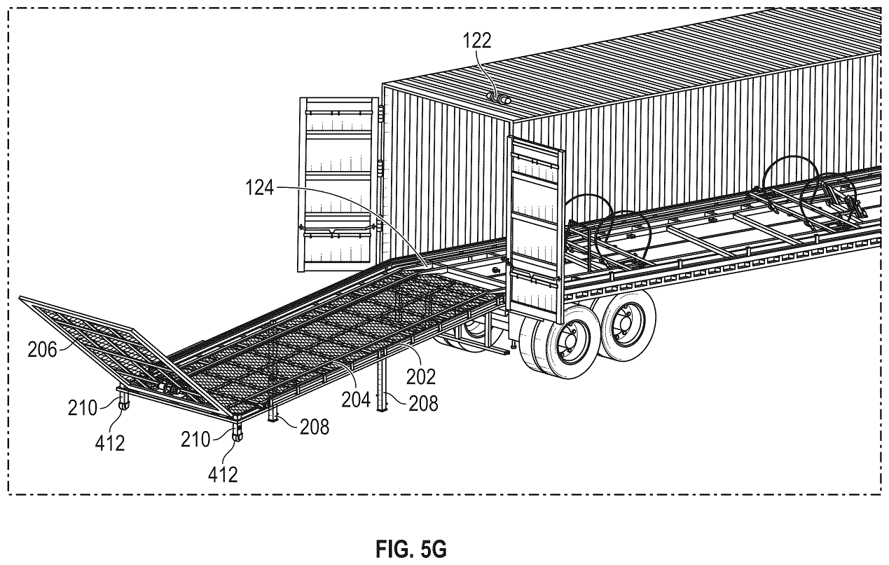

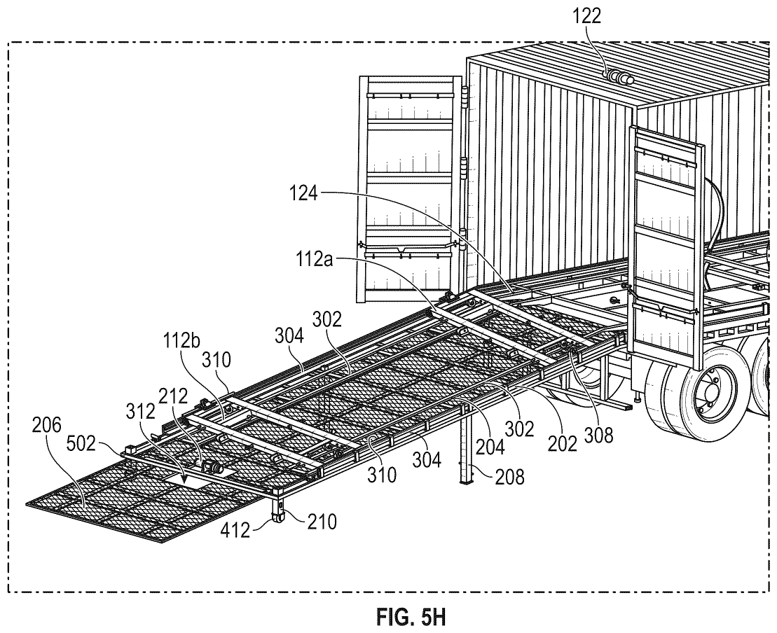

Turning to FIGS. 2D-2E, perspective and side views of example ramp adapters 124 in connection with the ramp 108 and rack 104 (FIGS. 2D and 2E) and in storage (FIG. 2F), are shown, according to one embodiment of the present disclosure. As described further in regard to FIGS. 5A-5H, the ramp 108 is stored for shipping by folding the ramp 108 into the opening 138 of the container 102. However, as shown in FIG. 2D, the ramp adapters 124, when in connection with the ramp 108 and rack 104 to facilitate trolley 112 movement into the container 102, are set on top of the top section 202 of the ramp 108. Thus, in at least one embodiment, the ramp adapters 124 are removable so that the ramp 108 can fold into the container 102. Further, in some embodiments, and as shown in more detail in FIG. 5A, the ramp 108, when stored, leans into the container 102 at an angle such that either the rack 104 or the ramp 108 may be damaged if the rack 104 and ramp 108 were permanently connected to each other. Thus, the ramp adapters 124 may be removed and stored at a point in the container 102 so that the ramp 108 can be stored inside the container 102 without damaging any other component of the system 100.

In multiple embodiments, the system 100 may utilize one or more than one ramp adapter 124 when loading or unloading vehicles 101 from the container 102. As shown in the figures, two ramp adapters 124 are utilized, though, in other embodiments, a single ramp adapter 124 may be utilized to perform the same function as the two ramp adapters 124. In some embodiments, each ramp adapter 124, as shown in FIG. 2D, may include an adapter guide track 220, two adapter caster tracks 222, and one or more adapter supports 226. The ramp adapter 124 may also define an opening within one of the adapter guide track 220, adapter caster tracks 222, or adapter supports 226 so that the ramp adapter 124 may be connected to an adapter latch 224 (for when the system 100 is being utilized to load or unload vehicles 101, as shown in FIG. 2D) or a storage latch 228 (for when the container 102 is being shipped and the ramp adapters 124 are stored, as shown in FIG. 2F). The adapter supports 226 may connect and support the adapter guide track 220 and adapter caster tracks 222. In at least one embodiment, the adapter supports 226 may extend from one ramp adapter 124 to the other ramp adapter 124, such that it is a single ramp adapter 124. In such an embodiment, the single ramp adapter 124 may be stored on the door 106 with the extra trolleys 112, may be stored on a side wall 130 or on the floor 134 of the container 102, or may be foldable (e.g., utilizing hinges) for ease of storage.

In many embodiments, as shown in FIGS. 2D and 2E, when loading or unloading a vehicle 101, each ramp adapter 124 is connected to an adapter latch 224, such that the adapter tracks 222 for each ramp adapter 124 are aligned with the corresponding ramp caster tracks 302 and the rack caster tracks 604, and the adapter guide track 220 is aligned with the corresponding ramp guide track 304 and the rack guide track 602, so that the trolleys 112 may be pulled by a mounted winch 802 from the ramp 108 to the ramp adapters 124 to the rack 104, or by the ramp winch 212 from the rack 104 to the ramp adapters 124 to the ramp 108.

As shown in FIGS. 2D-2F, the ramp 108 is connected to a plurality of ramp hinges 230, to allow the ramp 108 to be pulled into the container by the rear winch 122.

In several embodiments, as shown in FIG. 2F, the two ramp adapters 124 are each connected to a storage latch 228, which indicates that the container 102 is being shipped or stored, and vehicles 101 are not actively being loaded or unloaded from the container 102. When stored, the ramp adapters 124 are out of the way of the ramp 108 so that the ramp 108 may be folded up into the container 102. Once an operator begins to load or unload vehicles 101 in the container 102, the operator may unlatch the ramp adapters 124 from the storage latches 228, and connect each of ramp adapters 124 to the adapter latches 224 before loading or unloading vehicles 101.

Turning now to FIGS. 3A-3E, perspective, top, and detail views of the ramp 108 and container 102 are shown, according to one embodiment of the present disclosure. As shown in FIGS. 3A-3E, the ramp 108 may include one or more ramp caster tracks 302, one or more ramp guide tracks 304, a first trolley loading point 308 and a plurality of second trolley loading points 310. In many embodiments, each of the one or more ramp guide tracks 304 may define a ramp guide track opening 306, so that one or more guide rollers 710 (as shown in more detail in relation to FIGS. 7A-7D) attached to each trolley 112 may enter into the guide track opening 306. In one or more embodiments, the one or more guide rollers 710 of the trolley 112 may roll through and are enclosed by the ramp guide track 304, the adapter guide track 220, and the rack guide track 602, so that the trolley 112 is pulled in a straight line into or out of the container 102.

In several embodiments, once the guide rollers 710 of a first trolley 112a are loaded into the ramp guide tracks 304 via the ramp guide track openings 306, and trolley casters 706 (as shown in more detail in relation to FIGS. 7A-7D) of the first trolley 112a are set on the ramp caster tracks 302, the first trolley 112a is moved up the ramp 108, either by a mounted winch 802 or manually by an operator to first trolley loading points 308. In certain embodiments, the first trolley loading points 308 are each an opening or other kind of connection point so that each trolley latch 712 (as shown in FIGS. 7A-7D) of the first trolley 112a connects to a separate first trolley loading point 308. In many embodiments, each of the first trolley loading points 308 are located on each of the two ramp guide tracks 304, and are the same or about the same distance up the ramp 108. The first trolley 112 is positioned to have a vehicle 101 loaded onto it or unloaded form it when the first trolley 112a is locked into place by the trolley latches 712 at the first trolley loading points 308. As shown in the figures herein, there is only one first trolley loading point 308 on each of the two ramp guide tracks 304; however, additional first trolley loading points 308 may be utilized in other examples of the present disclosure.

In multiple embodiments, once the first trolley 112a is loaded onto the ramp 108 as described above, the second trolley 112b may be loaded onto the ramp 108 using a similar method. For example, in one embodiment, the guide rollers 710 of the second trolley 112b are loaded into the ramp guide tracks 304 via the ramp guide track openings 306, and the trolley casters 706 of the second trolley 112b are set on the ramp caster tracks 302. Once securely on the ramp 108, the second trolley 112b is moved to one of the plurality of second trolley loading points 310, and locked into place at one of the plurality of second trolley loading points 310 in a similar manner as the first trolley 112a was locked into the first trolley loading point 308. Like the first trolley 112a, the second trolley 112b has two trolley latches 712 and each connect with one of the plurality of second trolley loading points 310. The second trolley 112b has a plurality of loading points 310 located on each of the ramp guide tracks 304 in the middle section 204 of the ramp 108, unlike the single first trolley loading point 308 for the first trolley 112a. The multiple second trolley loading points 310 allow for an operator to change the distance between the first trolley 112a and the second trolley 112b so that the system 100 can accommodate different size vehicles 101. For example, a pick-up truck may have a distance between the front wheels and back wheels of 8 feet, but a sports car may have a distance between the front wheels and back wheels of only 6 feet. Thus, the second trolley 112b has multiple loading points 310 to account for the differences in distances between the wheels of different vehicles.

Once the distance between the front and back wheels of a vehicle 101 being loaded into the container 102 is known, the second trolley 112b may be loaded and locked into place at one of the plurality of second trolley loading points 310 such that the first trolley 112a and second trolley 112b are appropriately spaced apart so that the vehicle 101 may be successfully loaded onto the trolleys 112. After the wheels of the vehicle 101 are strapped onto the trolleys 112 via the wheel tie-down ratchet straps 116, the front of the vehicle is connected to the front bars 117 via the front bar tie-down chains 118, and the mounted winch 802 is connected to the first trolley 112a, the trolley latches 712 of the first and second trolleys 112 are unlocked, unlatched, or disconnected from the first trolley loading point 308 and the one of the plurality of the second trolley loading points 310, respectfully, and the mounted winch 802 may pull the vehicle 101 into the container 102.

In several embodiments, as shown in FIG. 3E, the bottom section 206 of the ramp 108 may define a bottom section opening 312. The bottom section opening 312 is proximate to the ramp winch 212, and allows for the bottom section 206 to be folded over the ramp winch 212. For example, when the ramp 108 is stored in the container 102, the ramp winch 212 is partially extended through the bottom section opening 312, because the bottom section 206 is folded over and onto the middle section 204.

In many embodiments, the method of unloading a vehicle 101 begins with disconnecting the rear tie-down ratchet strap 114, and connecting the ramp winch 212 to the second trolley 112b to pull the vehicle 101 out of the container 102. In some embodiments, the mounted winch 802 may provide a counter force against the ramp winch 212, so that the trolleys 112 do not lose control and roll down the ramp 108. When the trolley latches 712 of the first trolley 112a arrive at the first trolley loading point 308, the trolley latches 712 of the second trolley 112b should also have arrived at one of the plurality of second trolley loading points 310, and each of the trolley latches may be latched or connected to the respective loading point. Thereafter, the front bar tie-down chains 118 are disconnected from the vehicle 101, the wheel tie-down ratchet straps 116 are removed from around the wheels of the vehicle 101, and the ramp winch 212 and mounted winch 802 are disconnected from the trolleys 112, the vehicle 101 may be driven down and off the ramp 108.

In several embodiments, as shown in FIG. 3E, the bottom section 206 of the ramp 108 may define a bottom section opening 312. The bottom section opening 312 is proximate to the ramp winch 212, and allows for the bottom section 206 to be folded over the ramp winch 212. For example, when the ramp 108 is stored in the container 102, the ramp winch 212 is partially extended through the bottom section opening 312, because the bottom section 206 is folded over and onto the middle section 204.

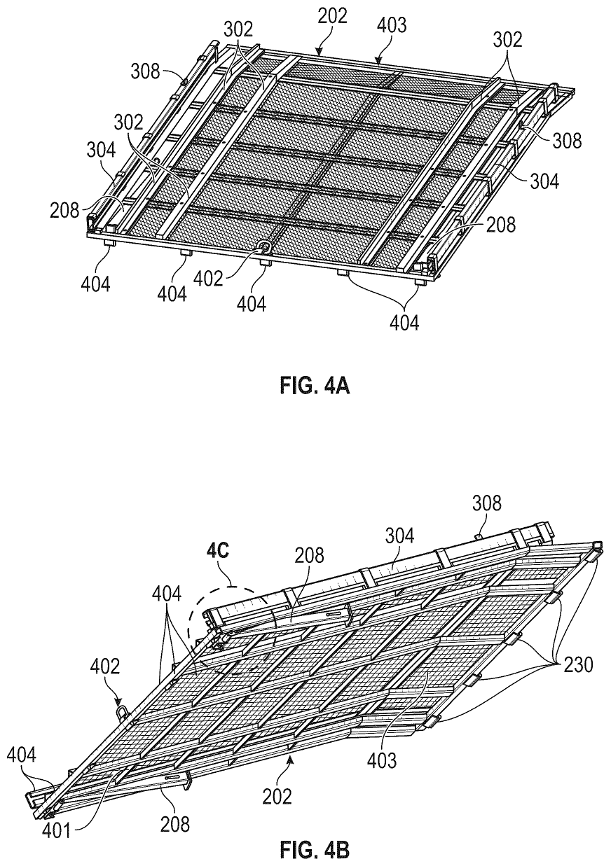

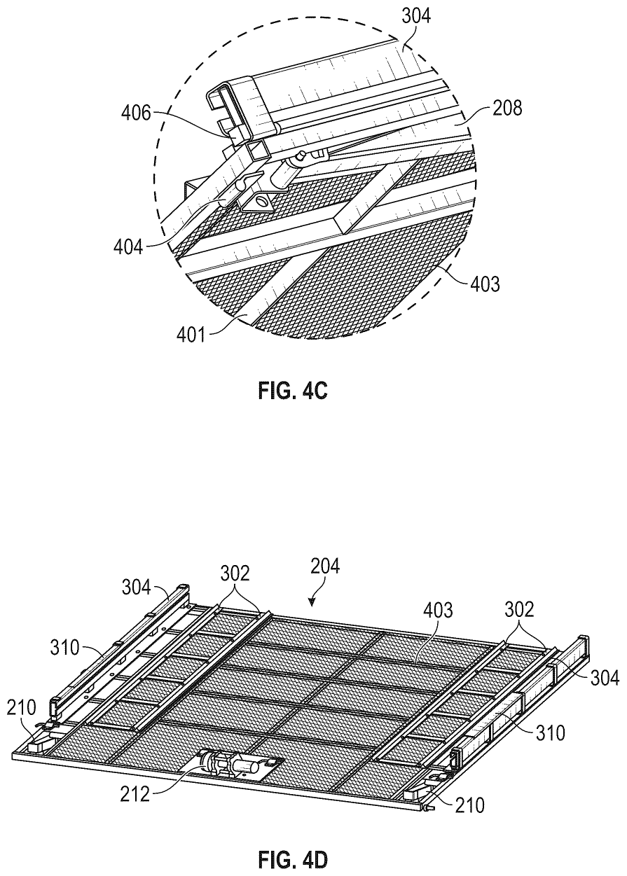

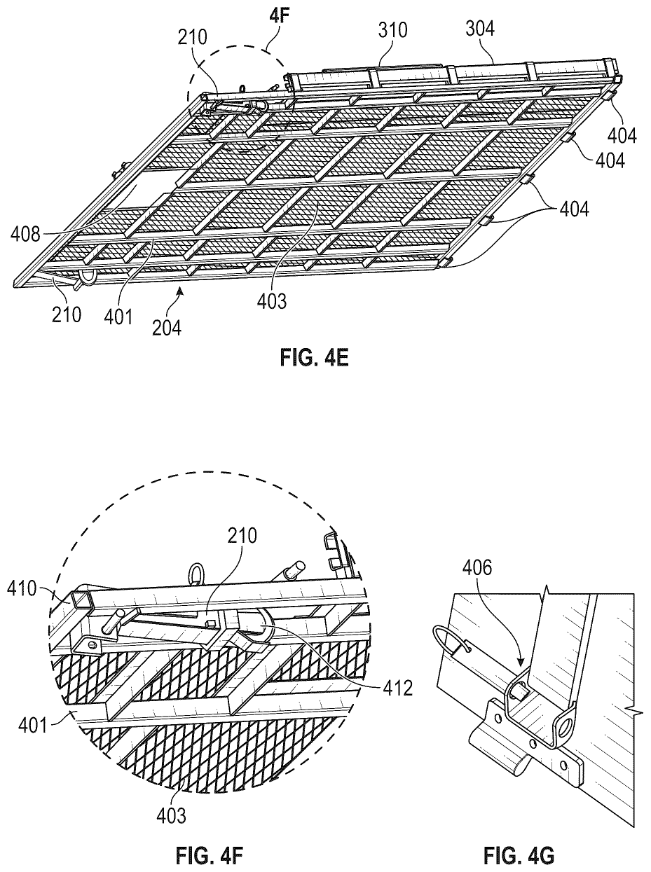

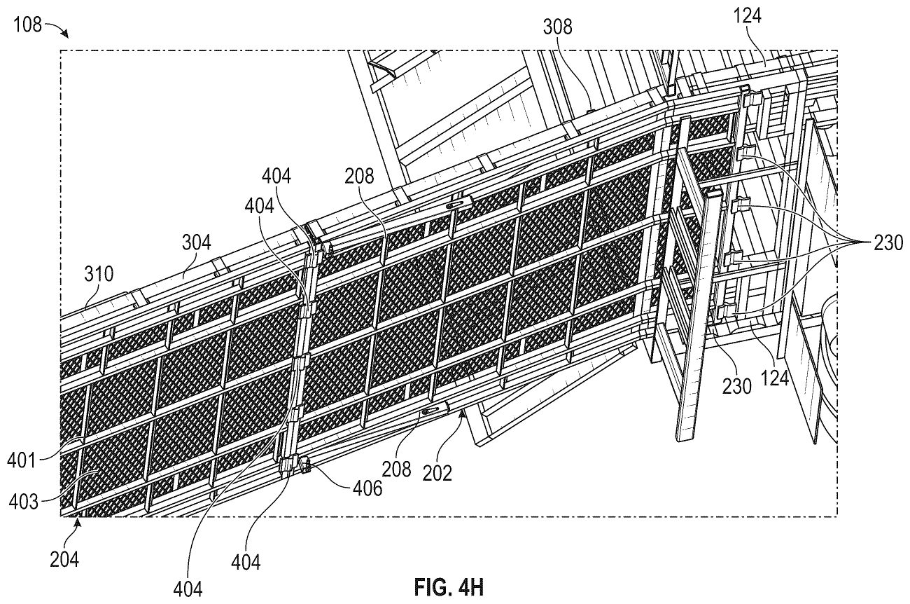

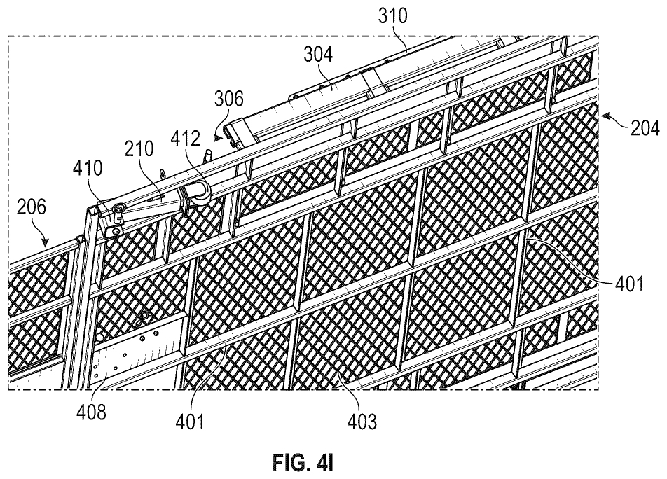

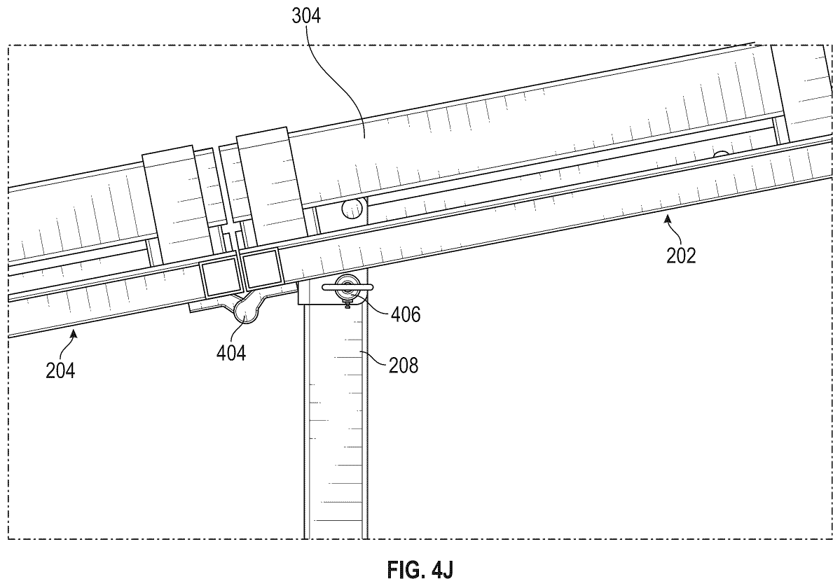

Turning to FIGS. 4A-4J, perspective and side views of portions of the ramp 108 are shown, according to one embodiment of the present disclosure. The ramp 108 includes a ramp frame 401 and decking 403 on top of the ramp frame 401. The ramp frame 401 may include a plurality of supports in a lattice or grid formation, which may be made of a metal, such as, but not limited to, steel or aluminum, or may be made of a hard plastic or wood, or any other material that can support the ramp 108. The decking 403 may be made of a sheet metal, a metal mesh, hard plastic, wood, or any other material that can support the functions of the ramp 108. In one or more embodiments, the ramp guide tracks 304 and ramp caster tracks 302 may extend on the top surface of the decking 403 on each of the top section 202 and middle section 204, where the bottom surface of the decking 403 is attached to the ramp frame 401.

The ramp top section 202, as shown in FIGS. 4A-4C, includes the ramp frame 401 and the decking 403, and may include two ramp guide tracks 304 and four ramp caster tracks 302 attached a top side of the decking 403 (opposite the side attached to the ramp frame 401). In many embodiments, the ramp top section 202 also includes two first trolley loading points 308, one on each of the ramp guide tracks 304. In some embodiments, the ramp top section 202 may also include the ramp hinges 230 on one end of the top section 202 and ramp middle section hinges 404 at the opposite end. Additionally, a ramp connection point 402 is attached at the end of the top section 202 proximate to the middle section hinges 404. In many embodiments, the rear winch 122 connects to the ramp connection point 402 to raise or lower the ramp 108. In one embodiment, the ramp connection point 402 may be a D-ring, but may be any connection device in which a winch can connect to so that the ramp 108 may be raised or lowered.

In an alternate embodiment, the cord attached to the rear winch 122 may pass through one or more pulleys so that the cord extends through or proximate to the ramp 108 and is utilized, instead of the ramp winch 212, to pull the vehicles 101 out of the container 102 and down the ramp 108.

The top section 202 also includes one or more top section support tubes 208. In one embodiment, the top section 202 includes two top section support tubes 208, but it will be understood that other embodiments of the present disclosure may include any number of top section support tubes 208. As shown in FIGS. 4A-4C, the top section support tubes 208 are in a stowed position, which minimizes the space needed to fold and store the ramp 108. As shown in FIGS. 5A-5H, as the ramp 108 is folded or unfolded, the top section support tubes 208 may rotate so that when the ramp 108 is fully extended, the top section support tubes 208 are perpendicular to the ground and supporting the ramp 108. In some embodiments, each top section support tube 208 may include a top section support tube latch 406 the end of the top section support tube 208 that is connected to the top section 202. When the top section support tube latch 406 is in a locked or latched position, the top section support tube 208 may not rotate, but when the top section support tube latch 406 is unlocked or unlatched, the top section support tube 208 may freely rotate. An operator may lock or unlock the top section support tube latch 406. For example, as the ramp 108 is being unfolded, an operator may unlock the top section support tube latch 406 so that the top section support tube 208 can rotate so that it is perpendicular to the ground. The operator may lock the top section support tube latch 406 once the top section support tube 208 is in a correct position for supporting the ramp 108. Similarly, when the ramp 108 is being folded into the container 102 for storage or shipping, an operator may unlock the top section support tube latch 406 so that the top section support tube 208 may rotate into the stowed position as the ramp 108 is folded into the container 102. The operator may then lock the top section support tube latch 406 when the top section support tube 208 is in the stowed position.

The ramp middle section 204, as shown in FIGS. 4D-4F, includes the ramp frame 401 and the decking 403, and may include two ramp guide tracks 304 and four ramp caster tracks 302 attached a top side of the decking 403 (opposite the side attached to the ramp frame 401). In many embodiments, the ramp middle section 204 also includes two sets of the plurality of second trolley loading points 310, one on each of the ramp guide tracks 304. In some embodiments, the ramp middle section 204 may also include the ramp middle section hinges 404 at one end (to connect with the ramp middle section hinges 404 attached to the ramp top section 202) and ramp bottom section hinges 502 (as shown in FIG. 5C). In many embodiments, the middle section 204 includes a ramp winch mounting plate 408 that the ramp winch 212 is mounted onto. In several embodiments, the ramp winch mounting plate 408 is connected to the decking 403 and/or the frame 401 proximate to the end of the middle section 204 that the ramp bottom section hinges 502 are attached.

The ramp middle section 204 also includes one or more middle section support tubes 210. In one embodiment, the ramp middle section 204 includes two middle section support tubes 210, but it will be understood that other embodiments of the present disclosure may include any number of middle section support tubes 210. As shown in FIGS. 4D-4F, the middle section support tubes 210 are in a stowed position, which minimizes the space needed to fold and store the ramp 108. As shown in FIGS. 5A-5H, as the ramp 108 is folded or unfolded, the middle section support tubes 210 may rotate so that when the ramp 108 is fully extended, the middle section support tubes 210 are perpendicular to the ground and supporting the ramp 108. In some embodiments, each middle section support tube 210 may include a middle section support tube latch 410 one end of the middle section support tube 210 that is connected to the middle section 204, and a middle section support tube caster 412 at the other end. The middle section support tube caster 412 may be a caster or another rotatable object that facilitates movement of the ramp 108 on the ground. When the middle section support tube latch 410 is in a locked or latched position, the middle section support tube 210 may not rotate, but when the middle section support tube latch 410 is unlocked or unlatched, the middle section support tube 210 may freely rotate. An operator may lock or unlock the middle section support tube latch 410. For example, as the ramp 108 is being unfolded, an operator may unlock the middle section support tube latch 410 so that the middle section support tube 210 can rotate so that it is perpendicular to the ground. The operator may lock the middle section support tube latch 410 once the middle section support tube 210 is in a correct position for supporting the ramp 108. As the ramp 108 is lowered by the rear winch 122, the middle section support tube casters 412 may contact the ground. Once the middle section support tube casters 412 have contacted the ground, as the ramp 108 continues to be lowered, the middle section support tube casters 412 roll away from the container 102 due to the weight of the ramp 108 and angle at which the ramp 108 is being lowered. The middle section support tube casters 412 roll until the middle section 204 and top section 202 are in the same plane and cannot be lowered any further.

Similarly, when the ramp 108 is being folded into the container 102 for storage or shipping, an operator may unlock the middle section support tube latch 410 so that the middle section support tube 210 may rotate into the stowed position as the ramp 108 is folded into the container 102. The operator may then lock the middle section support tube latch 410 when the middle section support tube 210 is in the stowed position.

In many embodiments, each of the top section support tubes 208 and the middle section support tubes 210 may be telescoping, such that the lengths of the top section support tubes 208 and middle section support tubes 210 may be adjustable.

As shown in FIG. 4G, the top section support tube latch 406 may be unlocked or unlatched such that the top section support tube 208 can rotate to be in a stowed position or in an operating position (as shown in FIG. 4J). The middle section support tube latch 410 is analogous to the top section support tube latch 406.

Turning to FIGS. 5A-5H, perspective views of the ramp 108 in various stages of unfolding are shown, according to one embodiment of the present disclosure. To start, as shown in FIGS. 5A-5C, the ramp 108 is folded up and inside the container 102 so that the container 102 may be stored or shipped. The ramp hinge 230, as shown in FIG. 5A, is rotated at an angle so that the top section 202 is leaning into the container 102, and the ramp bottom section hinge 502 is rotated so that the bottom section 206 and the middle section 204 are generally parallel to each other while in the stored position. Also shown in the FIG. 5A is the ramp winch 212 extending through the bottom section opening 312, and the ramp adapters 124 in a stored position and not attached to adapter latch 224. As shown in FIG. 5B, the ramp middle section hinges 404 are rotated at an angle so that the top section 202 and middle section 204 are generally parallel to each other while stored.

As shown in FIG. 5C, when the ramp 108 is folded and stored inside the container 102, the ramp 108 blocks all human entry into the container 102. This prevents any person from accessing and stealing the vehicles 101 in the container 102. Further, the ramp 108 must unfold in order to remove the vehicles 101 from the container 102, and in most shipping circumstances, the shipping containers are packed so tightly together (either on a ship, train, or semi-trailer truck), that the ramp 108 does not have enough room to unfold. The ramp 108 has a length of about 21 feet when unfolded completely so that the vehicles 101 can be driven out of the container 102 and down the ramp 108, and so, even if criminals managed to gain access inside the container 102 (i.e., get around the ramp 108), the ramp 108 would not have enough room to unfold, and so the vehicles 101 could not be removed from the container 102. Thus, the ramp 108 provides theft protection during shipping.

In several embodiments, as shown in FIG. 5C, the middle section 204 and bottom section 206 are connected via the ramp bottom section hinges 502. In many embodiments, one or more bottom section storage latches 504 may be attached to the ramp winch mounting plate 408. In one or more embodiments, when the ramp 108 is stored and the bottom section 206 is in the stored position in which is folded onto the middle section 204 (over the ramp winch 212), the bottom section storage latches 504 may be pushed into a locked position, whereby the bottom section storage latches 504 prevent the bottom section 206 from moving or unfolding. Also, the middle section 502 may include one or more middle section storage latches 506 that are attached to the ramp frame 401 or decking 403. When the middle section 204 is in the stored position, the one or more middle section storage latches 506 may be pushed into a locked position to prevent the middle section 204 from moving or unfolding.

As shown in FIG. 5D, the ramp 108 is in an early stage of unfolding from the container 102 (or, conversely, at a late stage of being folded into the container 102). As the rear winch 122 lowers the ramp 108 via ramp connection point 402, the top section 202 rotates around the ramp hinges 230, and the middle section 204 and bottom section 206 are consequently moved away from the container 102. As the ramp 108 is lowered, an operator may unlatch the top section support tube latches 406 and the middle section support tube latches 410 so that the top section support tubes 208 and bottom section support tubes 210 may rotate or be moved from the stored position to an operating position. As shown in FIGS. 5F and 5G, the middle section support tube latches 410 are latched so that the middle section support tubes 210 are locked in the operating position, and the top ramp support tubes 208 are in between a stored position and operating position, and as the ramp 108 continues to be lowered, the top section support tubes 208 will rotate until they are in position for the top section support tube latches 406 to lock the top section support tubes into the operating position. In many embodiments, the middle section support tube casters 412 contact the ground as the ramp 108 is being lowered, and the weight of the top section 202 forces the middle section support tube casters 412 away from the container 102, until the top section 202 and middle section 204 are completely unfolded (shown in FIGS. 5H and 5I), and both the top section support tubes 208 and middle section support tubes 210 are in contact with the ground. The ramp caster tracks 302 and ramp guide tracks 304 on each of the top section 202 and bottom section 204 are aligned so that a trolley 112 can seamlessly transition from the middle section 204 to the top section 202.

The bottom section 206 may be unfolded from the middle section 204 by unlocking the bottom section storage latches 504 and pulling the bottom section 206 around the bottom section hinges 502 until the end of the bottom section 206 opposite the end attached to the middle section 204 by the bottom section hinges 502 contacts the ground, as shown in FIG. 5H). As shown in FIG. 5H, the ramp 108 is unfolded so that it can accept one or more trolleys 112 and vehicles 101 for loading into the container 102.

During the unfolding process of the ramp 108, the ramp adapters 124 are first in the stored position (latched to storage latch 228), as shown in FIG. 5F, but may be moved and latched to the adapter latches 224 when the top section 202 and middle section 204 are fully unfolded/extended (as shown in FIGS. 5G-5H).

Turning now to FIGS. 6A-6F, perspective, side, top, and detailed views of the rack 104 are shown, according to one embodiment of the present disclosure. In several embodiments, the rack 104 includes one or more rack sections. For example, as shown in FIG. 6A, the rack 104 includes rack section 104a, rack section 104b, and rack section 104c, and each rack section is the same or about the same length as the others, though other embodiments of the present disclosure may include rack sections of varying length. As shown in FIG. 6A, each rack section 104a, 104b, and 104c may include similar components, such as one or more rack guide tracks 602, one or more rack caster tracks 604, one or more rack supports 606, one or more D-ring tie downs 608, one or more floor mounts 610, and one or more winch mount assembly mount channels 612. In many embodiments, each rack section 104a, 104b, and 104c includes a rectangular rack frame 601 that has a width that is the same or about the same as the width as the floor 134 of the container 102, and a length that, when added to the length of the other rack sections, is shorter than the length of the floor 134 of the container 102, so that the ramp adapters 124 may be placed in between the rack 104 and the ramp 108.

In many embodiments, the rack guide tracks 602 are attached on top of the two edges of the rack frame 601 running the length of the container 102, so that the width in between the rack guide tracks 602 is the same width as the width of the rack frame 601. In some embodiments, the rack caster tracks 604 are connected to the rack frame 601 so that each of the rack caster tracks 604 are parallel to each other and to the rack guide tracks 602. The rack caster tracks 604 are spaced apart have the same width dimensions as the ramp adapter caster tracks 222 and the ramp caster tracks 302. In a preferred embodiment, each rack section 104a, 104b, and 104c has four rack caster tracks 604, and can be defined as two outer rack caster tracks 604a that are closer to the side walls 130 of the container 102 and two inner rack caster tracks 604b that are further from the side walls 130 of the container 102.

In at least one embodiment, each rack section 104a, 104b, and 104c includes rack supports 606 that are placed in between the rack frame 601 and rack caster tracks 604 or in between the rack caster tracks 604 to provide support to the rack 104. In several embodiments, a plurality of D-ring tie downs 608 and/or a plurality of floor mounts 610 may be attached to the rack frame 601, rack caster tracks 604, and/or the rack supports 606. The D-ring tie-downs 608 may be used as tie-down points for the rear tie-down ratchet straps 114, so that the rear tie-down ratchet straps 114 may be connected to the rack 104 when the vehicles 101 are loaded into the container 102. In many embodiments, the floor mounts 610 may define an opening so that a bolt or screw or other connection device can be used to attach the floor mounts 610 to the floor 134 of the container 102.

In multiple embodiments, each rack section 104a, 104b, and 104c may also include one or more winch mount assembly mount channels 612 attached to the inner rack caster tracks 604b so that a winch mount assembly 110 can be attached to the respective rack section. Each winch mount assembly mount channel 612 may accept a portion of the winch mount assembly 110 (for example, the winch mount beam 803 as shown in FIGS. 8A-8C), and may further define an opening that a latch or pin may pass through to secure the winch mount assembly 110 to the winch mount assembly mount channel 612.

In some embodiments, the rack 104 may be constructed by inserting each of the rack sections 104a, 104b, and 104c into the container 102, so that the rack guide tracks 302 and rack caster tracks 304 on each section are aligned. In many embodiments, the rack frames 602 of adjoining rack sections (e.g., the rack frame 601 of rack section 104a and the rack frame 601 of rack section 104b), may be attached or connected by bolts or screws to secure the rack sections together. Thereafter, rack 104 may be attached to the floor 134 by bolting through the floor mounts 612.

Turning now to FIGS. 7A-7D, perspective, side, and top views of an example trolley 112 are shown, according to one embodiment of the present disclosure. In several embodiments, the trolley may include a rectangular trolley frame 701, though other frame shapes may be utilized. The rectangular trolley frame 701 may have a width of slightly less than the width between the rack guide tracks 602, though the trolley guide rollers 710 may extend from the trolley frame 701 to the rack guide tracks 602, making the effective width of the trolley 112 the same or about the same as the width between the rack guide tracks 602.

The trolley frame 701 may also include one or more trolley caster supports 704 (in a preferred embodiment, as shown in FIGS. 7A-7D, the trolley frame includes four trolley caster supports 704) and one or more trolley casters 706. The one or more trolley caster supports 704 extend the length of the trolley frame 701, and the trolley casters 706 are attached to a bottom surface of the trolley caster supports 706 so that when the trolley casters 706 are on any of the ramp caster tracks 302, adapter caster tracks 222 or rack caster tracks 604, the trolley frame 701 is above the trolley casters 706. In some embodiments, each of the one or more trolley caster supports 704 includes at least one trolley caster 706. In a preferred embodiment, at least one of the trolley caster supports 704 includes two or more trolley casters 706 so that the trolley 112 has at least two points of contact on any of the sets of caster tracks for balance and support purposes.

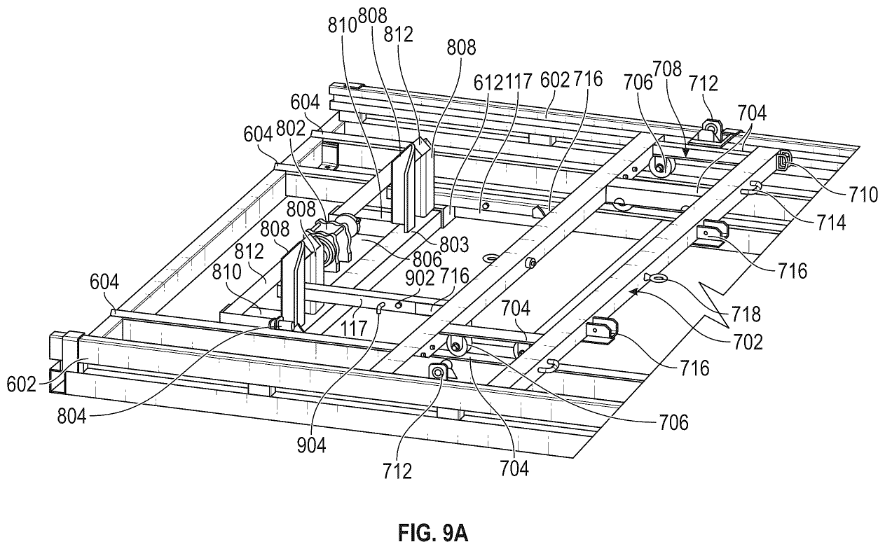

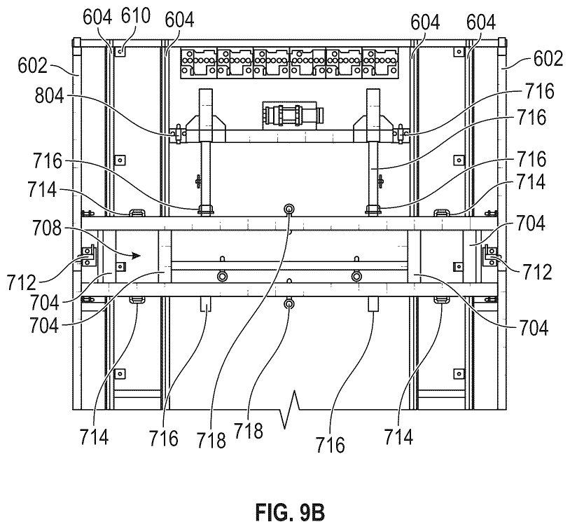

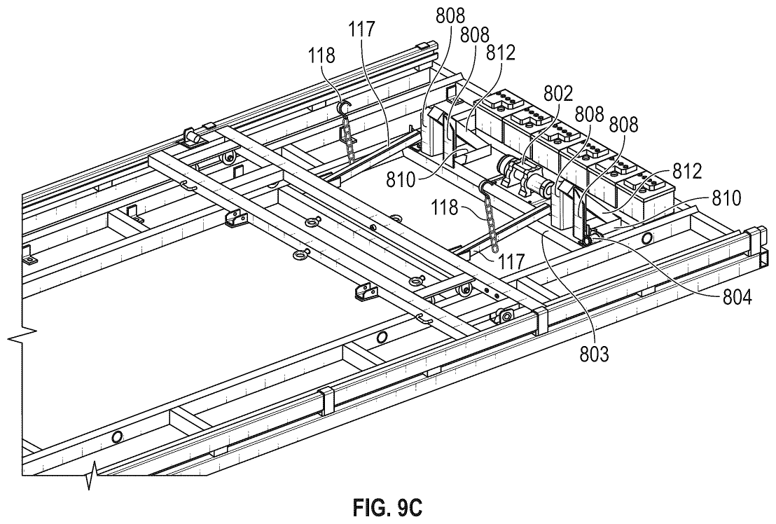

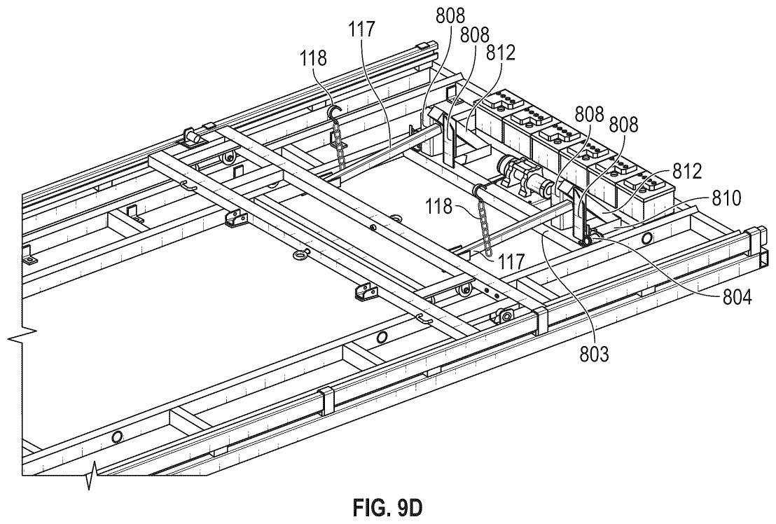

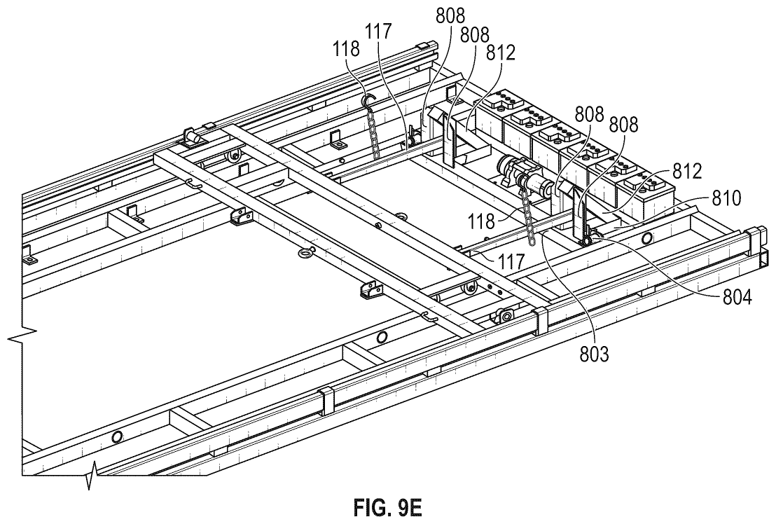

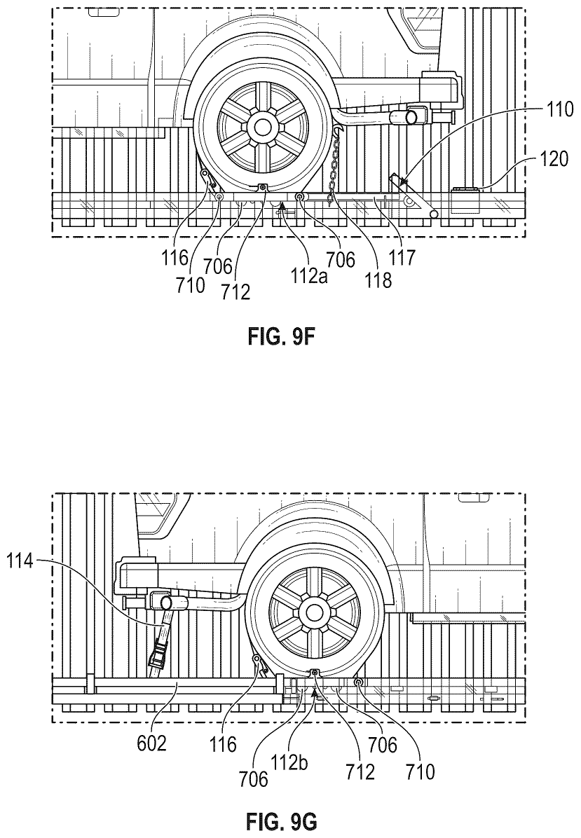

In many embodiments, the ramp caster tracks 302, the adapter caster tracks 222, and the rack caster tracks 604, and the trolley casters 706 may be shaped as mating pairs so that the trolley casters 706 are prevented from slipping or falling off the aforementioned caster tracks. For example, in a preferred embodiment, each of the trolley casters 706 may include a rotational piece that includes a circular concave divot around the circumference of the rotational piece (as seen in FIG. 7C), and each of the ramp caster tracks 302, the adapter caster tracks 222, and the rack caster tracks 604 may be shaped having an opposing convex point (as seen in FIG. 9C), so that the trolley casters 706 fit over the caster tracks.

The trolley frame 701 and the trolley caster supports 706 may be configured as to define two wheel pits 708. The two wheel pits 708 may be the width between the two front wheels (or two back wheels) of the vehicle 101, so that, when the vehicle 101 is driven onto the trolley 112 for loading into the container 102, each wheel of the vehicle 101 rests on the trolley frame 701 and partially extends through the wheel pit 708, so that the edges of the trolley frame 701 provides resistance to the tires to further prevent movement or rolling of the tires during shipping.

The trolley frame 701 may further include one or more guide rollers 710, one or more trolley latches 712, one or more tie doom loops 714, one or more front bar mount channels 716, and one or more winch attachment points 718. In many embodiments, the trolley frame 701 may include each of the components on each of the front and back sides of the trolley frame 701, so that the trolley 112 can be loaded in either direction (e.g., the sides are mirror images of each other). In other embodiments, the trolley frame 701 may include components on only one side, or in any other configuration that would allow the trolley 112 to be utilized as described herein.

In many embodiments, the guide rollers 710 may be inserted into the ramp guide track opening 306 and, as the trolley 112 is pulled into the container 102, guides the trolley 112 on each of the ramp guide tracks 304, adapter guide tracks 220, and rack guide tracks 602. In several embodiments, the trolley guide rollers 710 may be attached to the trolley frame 701 and extend from the frame 701 to and into the aforementioned guide tracks. The guide rollers 710 may include a rotational piece to facilitate movement/pulling of the trolley 112 by the mounted winch 802 or ramp winch 212.

In several embodiments, the trolley latches 712 are attached to the trolley frame 701 at each of the opposing ends separated by the width of the trolley frame 701, and utilized at the ramp 108 for latching the trolley into place at either the first trolley loading point 308 or one of the plurality of second trolley loading points 310. The trolley latches 712 may be spring latches or any other kind of latching or locking mechanism.

In multiple embodiments, the tie doom loops 714 are attached on the trolley frame 701 proximate to the trolley caster supports 706 and tire pit 708. Each of the tie doom loops 714 may be a connection point for a wheel tie-down ratchet strap 116. In at least one embodiment, the front bar mount channel 716 may be attached to and extend out from the trolley frame 701 in order to accept or receive the front bar 117, and may include an opening or other mechanism for securing the front bar 117 to the front bar mount channel 716. For example, in one embodiment, the front bar mount channel 716 and the front bar 117 may define openings such that a front bar connection device 902 (as shown in FIG. 9A) (such as, but not limited to, a Clevis pin with spring retainer) may be utilized to secure the front bar 117 to the front bar mount channel 716. In one or more embodiments, the one or more winch attachment points 718 may be connected to and extend out from the trolley frame 701, and the cord of either the mounted winch 802 or ramp winch 212 may be connected to one of the winch attachment points 718. In many embodiments, each winch attachment point 718 may be an eye bolt, D-ring, or other connection device. In other embodiments, the trolley frame 701 may not include a winch attachment point 718, so that the cord of the mounted winch 802 or the ramp winch 212 may be wrapped around the trolley frame 701 and connected to itself.

Turning to FIGS. 8A-8C, perspective, front, and side views of an example winch mounting assembly 110 are shown, according to one embodiment of the present disclosure. In several embodiments, the winch mounting assembly may include a winch mount beam 803 that extends the width between the two inner rack caster tracks 604b, one or more winch mount assembly latches 804, a mounted winch 802 attached to a winch mount plate 806, one or more front bar guideposts 808, a deflector base 810, and a front bar deflector 812.

In some embodiments, the winch mount assembly mount channel 612 receives the ends of the winch mount beam 803. Each end of the winch mount beam 803 includes a winch assembly latch 804, and each winch assembly latch 804 latches or locks on the winch mount assembly mount channel 612 to secure the winch mount beam 803 to the rack 104. The winch assembly latch 804 may be a spring latch or any other type of latch or lock that can secure the winch mount beam 803 to the winch mount assembly mount channel 612. In a preferred embodiment, the winch mount beam 803 may define an opening on each end, and the winch mount assembly mount channel 612 may define an opening that, when the winch mount beam 803 is placed into the winch mount assembly mount channels 612, the openings align and the winch assembly latch 804 extends through the openings to secure the winch mount assembly 110 to the rack 104.

In many embodiments, the winch mount plate 806 is attached to the winch mount beam 803 on the side opposite from the direction the trolley 112 is, such that, when a vehicle 101 is stored in the container 102 by the system 100, the winch mount beam 803 is in between the winch mount plate 806 and the trolley 112. The mounted winch 802 is connected to a top surface of the winch mount plate 803.

In several embodiments, the winch mount beam 803 may include one or more front bar guideposts 808 extending vertically from the winch mount beam 803. In a preferred embodiment, the winch mount assembly 110 includes four front bar guideposts 808. The four front bar guideposts 808 may be separated into two sets of two front bar guideposts 808, where each set of the two front bar guideposts 808 in each set is separated by more than the width of a front bar 117, so that as the trolley 112 is pulled towards the winch mount assembly 110, each front bar 117 on the trolley 112 extends in between a set of two front bar guideposts 808.

In multiple embodiments, each deflector base 810 extends horizontally away from the winch mount beam 803 (in the same direction as the winch mount plate 806), and connects to and supports a front bar deflector 812. In many embodiments, a front bar deflector 812 is connected to a deflector base 810 by welding or other connection methods and devices. Each front bar deflector 812 is positioned at an angle so that the front bar deflector extends from the deflector base 810 to the front bar guideposts 808. In some embodiments, the front bar deflector 812 may be the same width as the distance between two front bar guideposts 808, so that the front bar deflector 812 may be connected to each of the two front bar guideposts 808, via welding, bolting, or other connection methods. In multiple embodiments, the front bar deflectors 812 are aligned with the front bars 117, and are angled so that each of the front bars 117 contacts a front bar deflector 812 when the trolley 112 is pulled to the winch mount assembly 110 by the mounted winch 802. In several embodiments, as depicted in FIG. 9D, the front bar 117 is deflected downwards when the front bar contacts the front bar deflector 812, which causes the vehicle 101 to be pulled downwards due to being connected to the front bar tie-down chains 118, which further secures the vehicle 101 for storage. Each of the winch mount beam 803, winch mount plate 806, front bar guideposts 808, deflector bases 810, and front bar deflectors 812 may be made of a metal (such as, but not limited to, steel, aluminum, or other similar metals), hard plastic, wood, or other materials that may be utilized to perform the functions of the system 100.

Turning to FIGS. 9A-9G, side, top, and perspective views of examples of the trolley 112 interacting with the winch mount assembly 110 and final position of the vehicle 101 are shown, according to one embodiment of the present disclosure.

As shown in FIG. 9A, the trolley 112 has been pulled by the mounted winch 802 to the final stored position of the trolley 112. Each of the two front bars 117 have extended past and in between each of the two sets of front bar guideposts 808 and have contacted the front bar deflectors 812 to force the front bars 117 downwards. In several embodiments, the front bar connection device 902 prevents the front bar 117 from disconnecting from the trolley 112 while being forced downwards by the force created by the mounted winch 802 pulling the front bars 117 against the front bar deflectors 812. In several embodiments, the front bar tie-down chain 118 is connected to the front bar 117 by a front bar chain connection device 904. In many embodiments, the front bar chain connection device 904 may be a pin, a latch, or any other connection device that can connect the front bar tie-down chain 118 to the front bar 117.

FIGS. 9C-9E depict, in at least one embodiment, how the front bar deflectors 812 may facilitate the securing of the vehicle 101 for storage during shipping of the container 102. As shown in FIG. 9C, the front bars 117 are at a first position that is when the vehicle 101 is loaded onto the trolley 112 and the front bar tie-down chains 118 are connected to the vehicle 101 (the vehicle 101 not shown in FIGS. 9C-9E). As depicted in FIG. 9D, the trolley 112 has been pulled by the mounted winch 802 so that the front bars 117 have extended past and in between the front bar guideposts 808 and have contacted the angled front bar deflector 812. As shown in FIG. 9E, the mounted winch 802 has pulled the trolley 112 further towards the winch mount assembly 110, which causes the front bars 117 to be deflected or forced downwards by the front bar deflectors 812. The force of the front bars 117 being forced downwards causes the vehicle 101 to be pulled downwards due to the connection of the vehicle 101 to the front bars 117 via the front bar tie-down chains 118. The tension provided by the mounted winch 802 on the trolley 112 and the downward force exerted on the front bars 117 may prevent the vehicle 101 from moving during shipping, providing a self-tie-down system without any operator intervention.

As shown in FIG. 9F, the front tires of the vehicle 101 are shown in a final secured position. In one or more embodiments, the front bar tie-down chains 118 are connected to the undercarriage of the vehicle 101 at one end and to the front bars 117 at the other end by the front bar chain connection device 904. In at least one embodiment, the front bars 117 are contacted and forced downwards by the front bar deflectors 812, pulling the vehicle 101 downwards. Additionally, the wheel tie-down ratchet straps 116 are looped around the tires and connected to the tie doom loops 714 on the trolley 112.

As shown in FIG. 9G, the back tires of the vehicle 101 are shown in a final secured position. In one or more embodiments, the wheel tie-down ratchet straps 116 are looped around the tires and connected to the tie doom loops 714 on the trolley 112. In several embodiments, the rear tie-down ratchet strap 114 is connected to a D-ring tie down 608 at one end, and the other end is extended around a portion of the undercarriage of the vehicle 101 and connected to a second D-ring tie down 608, to further secure the vehicle for shipping. As shown in FIGS. 9F and 9G, the trolleys 112 provide radical rolling resistance to the vehicle 101 during shipping and storage. In the final stored position, the vehicle 101 is tied down and secured in three ways: each wheel is secured to a trolley 112 by a wheel tie-down ratchet strap 116, the rear frame of the vehicle 101 is secured to the rack 104 by the front bar tie-down chains 118, and the front frame of the vehicle is secured to the front bars 117 by the front bar tie-down chains 118, which are deflected downwards by the front bar deflectors 812 as described herein.

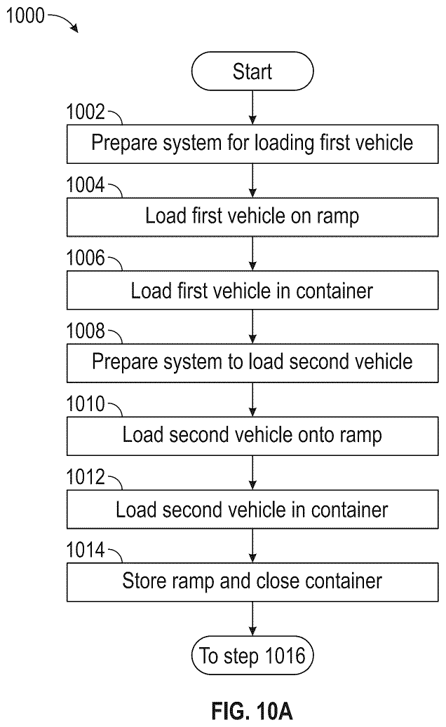

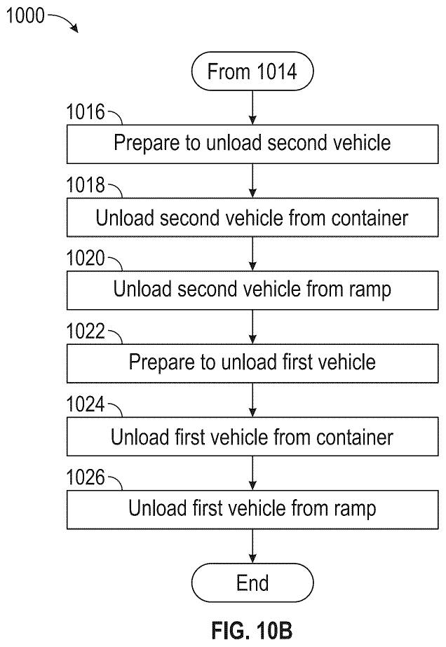

Turning to FIGS. 10A and 10B, a method 1000 for loading and unloading multiple vehicles 101a and 101b is shown, according to one embodiment of the present disclosure. In several embodiments, the system 100 may be utilized to store and ship a first vehicle 101a and a second vehicle 101b. In many embodiments, the rack 104 may be attached to the floor 134 of the container 102. In step 1002 of an example method 1000 for utilizing the system 100, the system 100 is prepared for loading the first vehicle 101a and second vehicle 101b into the container 102. In at least some embodiments, the ramp 108 may be unfolded from the container 102 and two trolleys, a first trolly 112a and a second trolley 112b, may be loaded onto the ramp 108 and locked into place at the first trolley loading point 308 and one of a plurality of second trolley loading points 310, respectively. The second trolley 112b may be locked at a loading point such that the distance between the trolleys 112a and 112b may be the distance between the front tires and back tires of the first vehicle 101a.

In an alternative embodiment, the first vehicle 101a may be driven onto the trolleys 112a and 112b before the trolleys 112a and 112b are loaded onto the ramp 108. Continuing in this alternate embodiment, the cord of the mounted winch 802a may be connected to the winch attachment point 718 of the trolley 112a, and the mounted winch 802a may pull the first vehicle 101a up and across the ramp 108.

At step 1004, a first vehicle 101a may be loaded and secured onto the trolleys 112a and 112b on the ramp 108 for loading into the container 102. In many embodiments, the first vehicle 101a may be secured for loading by attaching the wheel tie-down ratchet straps 116 around each of the tires and to the tie doom loops 714 of each trolley 112a and 112b. In some embodiments, the front bars 117 may be attached to the front bar mount channels 716 on the trolley 112a via front bar connection device 902, and the front bar tie-down chains 118 may be connected to the undercarriage of the first vehicle 101a and to the front bar 117 via front bar chain connection device 904. In many embodiments, the cord of the mounted winch 802a may be connected to the winch attachment point 718 of the trolley 112a.

At step 1006, the first vehicle 101a is loaded into the container 102. In some embodiments, once the first vehicle 101a is secured to the trolleys 112a and 112b and the cord of the mounted winch 802 is connected to the trolley 112a, an operator may turn on the mounted winch 802a at a switch at the rear of the container 102, so that the operator does not have to enter the container as the first vehicle 101a is being pulled into the container 102. In many embodiments, the mounted winch 802a is powered by the power source 120.

In one or more embodiments, the mounted winch 802a pulls the first vehicle 101a up the ramp 108, across the ramp adapters 124, and across the rack 104 towards the first winch mount assembly 110a, until the front bars 117 contact the front bar deflector 812 and are forced downwards. The operator may then switch the mounted winch 802a off and attach the rear tie-down ratchet strap 114 to the rack 104 and first vehicle 101a, which secures the first vehicle 101a in place for shipping.

At step 1008, the system 100 is prepared to load the second vehicle 101b. In at least one embodiment, the operator may then attach and secure a second winch mount assembly 110b to winch mount assembly mount channels 602. The second winch mount assembly 110b is attached behind the first vehicle 101 in the container 102. In many embodiments, the operator may also connect the second mounted winch 802 to the power source 120.

In some embodiments, a second set of trolleys 112a and 112b may be loaded onto the ramp 108 as described herein, and locked into place at the first trolley loading point 308 and one of the plurality of second trolley loading points 310 that corresponds to the length in between the front tires and back tires of a second vehicle 101b being loaded into the container 102.

At step 1010, the second vehicle 101b may be driven or loaded onto the first trolley 112a and the second trolley 112b on the ramp 108 and secured for loading. In many embodiments, the second vehicle 101b may be secured for loading by attaching the wheel tie-down ratchet straps 116 around each of the tires and to the tie doom loops 714 of each trolley 112a and 112b. In some embodiments, the front bars 117 may be attached to the front bar mount channels 716 on the trolley 112a via front bar connection device 902, and the front bar tie-down chains 118 may be connected to the undercarriage of the second vehicle 101b and to the front bar 117 via front bar chain connection device 904. In many embodiments, the cord of the mounted winch 802b may be connected to the winch attachment point 718 of the trolley 112a.

At step 1012, the second vehicle 101b is loaded into the container 102. In several embodiments, once the second vehicle 101b is secured to the trolleys 112a and 112b and the cord of the mounted winch 802b is connected to the trolley 112a, an operator may turn on the mounted winch 802b at a switch at the rear of the container 102, so that the operator does not have to enter the container as the second vehicle 101b is being pulled into the container 102. In many embodiments, the mounted winch 802b is powered by the power source 120.

In multiple embodiments, the mounted winch 802b pulls the second vehicle 101b up the ramp 108, across the ramp adapters 124, and across the rack 104 towards the second winch mount assembly 110b, until the front bars 117 contact the front bar deflector 812 and are forced downwards. The operator may then switch the mounted winch 802b off and attach the rear tie-down ratchet strap 114 to the rack 104 and second vehicle 101b, which secures the second vehicle 101b in place for shipping.

At step 1014, the ramp 108 is loaded and the container 102 is closed. In certain embodiments, the ramp adapters 124 are unlatched from the adapter latches 224 and moved and latched to the storage latches 228. In multiple embodiments, the ramp 108 is folded and stored in the container 102. In several embodiments, the operator may then connect a cord of the rear winch 122 to the ramp connection point 402 and switch the rear winch 122 on so that the rear winch 122 begins to pull the ramp 108. The bottom section 206 may be folded onto the middle section 204 and locked into place via the bottom section storage locks 504. The middle section support tube latch 410 of each middle section support tube 210 may be unlocked so that the middle section support tubes 210 can be rotated to the stored position. The top section support tube latch 406 of each top section support tube 208 may be unlocked or unlatched so that the top section support tubes 208 may be rotated to the stored position. Once the ramp 108 is folded into the container 102, the middle section storage latches 506 are latched into place to prevent the ramp 108 from falling against the doors 106. The doors 106 are then shut. When the doors 106 are shut, no person can see into the container 102 or look at the container 102 and know that a vehicle 101 is stored in the container 102, which provides security for the vehicle 101.

While the container 102 is in-transit, the vehicles 101a and 101b are secured by the system 100 in such a way that limits the damage to the vehicles 101a and 101b as compared to conventional vehicle shipping methods. The system 100 does not utilize rail chocks, and so there can be no rail chock jumping during transit. Additionally, because the vehicles 101a and 101b are secured to the rack 104, which is connected to the floor of the container 102, the vehicles 101a and 101b are in a low position in the container 102 during shipping (e.g., while being shipped on an intermodal well car), which limits the amount of vibration the vehicles 101a and 101b may experience during transit, as compared to conventional systems that ship vehicles in higher positions. Also, while the container 102 should not be allowed to undergo rail humping (e.g., the container 102 should have “Do Not Hump” on the side of the container 102), the system 100 limits the damage done to the vehicles 101a and 101b if the rail car that the container 102 is loaded onto is rail humped, as compared to convention systems for shipping vehicles.

At step 1016, the system 100 is prepared to unload the second vehicle 101b. Once the container 102 has been shipped, the ramp 108 is unfolded as described herein, and the ramp adapters 124 are attached to the adapter latches 224 so that the trolleys 112a and 112b may be removed from the container 102.

At step 1018, the second vehicle 101b is unloaded from the container 102. In many embodiments, the rear tie-down ratchet strap 114 attached to the second vehicle 101b is removed, and the cord of the ramp winch 212 is attached to the winch attachment point 718 of trolley 112b. In several embodiments, an operator may turn the ramp winch 212 on to pull the second vehicle 101b across the rack 104 and ramp adapter 124 and down the ramp 108. In some embodiments, the mounted winch 802b may also be turned on to provide tension so that the second vehicle 101b does not roll down the ramp 108 in an uncontrolled manner.

At step 1020, the second vehicle 101b is unloaded from the trolleys 112a and 112b and driven or rolled off of the ramp 108. In several embodiments, the first trolley 112a is latched onto the first trolley loading point 308 and the second trolley 112b is latched onto one of the plurality of second trolley loading points 310. The cord to the second mounted winch 802b is removed from the winch attachment point 718 on the first trolley 112a, the cord of the ramp winch 212 is disconnected from the winch attachment point 718 of the second trolley 112b, the front bar tie-down chains 118 are disconnected from the second vehicle 101b, the wheel tie-down ratchet straps 116 are disconnected, and the second vehicle 101b may be driven or unloaded off the ramp 108.

At step 1022, the system 100 is prepared to unload the first vehicle 101a. In many embodiments, the winch mount assembly 110b is unattached from the rack 104, and the rear tie-down ratchet strap 114 connected to the first vehicle 101a is unattached, and the cord of the ramp winch 212 is attached to the winch attachment point 718 of trolley 112b of the first vehicle 101a.

At step 1024, the first vehicle 101a is unloaded. In some embodiments, an operator may turn the ramp winch 212 on to pull the first vehicle 101a across the rack 104, ramp adapter 124 and down the ramp 108. In several embodiments, the mounted winch 802a may also be turned on to provide tension so that the first vehicle 101a does not roll down the ramp 108 in an uncontrolled manner.

At step 1026, the first vehicle 101a is unloaded from the trolleys 112a and 112b. In many embodiments, the first trolley 112a is latched onto the first trolley loading point 308 and the second trolley 112b is latched onto one of the plurality of second trolley loading points 310. The cord to the first mounted winch 802a is removed from the winch attachment point 718 on the first trolley 112a, the cord of the ramp winch 212 is disconnected from the winch attachment point 718 of the second trolley 112b, the front bar tie-down chains 118 are disconnected from the first vehicle 101a, the wheel tie-down ratchet straps 116 are disconnected, and the first vehicle 101a may be driven or unloaded off the ramp 108.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A vehicle transport and storage system, comprising:
a container having a floor, a first side wall opposing a second side wall, and an end wall affixed one end of each of the first side wall and the second side wall, each of the first side wall, second side wall and end wall affixed to the floor;
a rack, affixed to the floor of the container, having a first rack end positioned proximate to the end wall and a second rack end positioned opposite to the rack first end, comprising at least two rack caster tracks, wherein the at least two rack caster tracks extend from the first rack end to the second rack end and are positioned parallel to the first side wall and second side wall and having a track width that spans between the at least two rack caster tracks;
a ramp having a first ramp end connected to the floor at a location proximate to an opening of the container opposite of the end wall of the container and a second ramp end positioned opposite the first end, the ramp comprising at least two ramp caster tracks that extend from the first ramp end toward the second ramp end with the track width between the at least two ramp caster tracks;
at least two ramp adapters connected to the floor, each of the at least two ramp adapters having a first ramp adaptor end connected to the first ramp end and a second ramp adaptor end connected to the second rack end, wherein each of the at least two ramp adapters comprise a ramp adapter caster track that extends from the first ramp adaptor end to the second ramp adaptor end, with the track width between the ramp adapter caster tracks of the at least two ramp adapters so that the ramp adapter caster tracks are aligned with the ramp caster tracks and rack caster tracks;
a first trolley and a second trolley, each of the first trolley and the second trolley comprising a rectangular frame having two long sides and two short sides and each end of each of the long sides is connected to an end of each of the short sides, wherein the rectangular frame defines a rectangular cavity, and at least two casters that are removably engaged with each of the rack caster tracks, the ramp caster tracks and the ramp adapter caster tracks and movable along a length extending a combination of the ramp caster tracks, the ramp adapter caster tracks, and the rack caster tracks; and
a first mounted winch, connectable to the first trolley via a first winch cable, operative to pull the first trolley along at least a portion of the length extending a combination of the ramp caster tracks, the ramp adapter caster tracks, and the rack caster track in response to attaching the first winch cable to the first trolley and operating the first mounted winch.

2. The system of claim 1, further comprising a first winch mount assembly connected to the rack at a location proximate to the first rack end, wherein the first mounted winch is mounted to the first winch mount assembly.

3. The system of claim 3, further comprising a second winch mount assembly connected to the rack at substantially a midpoint between the first rack end and the second rack end, and wherein a second mounted winch is mounted to the second winch mount assembly.

4. The system of claim 3, further comprising a third trolley and a fourth trolley, wherein each of the third trolley and fourth trolley comprise a rectangular frame having two long sides and two short sides and each end of each of the long sides is connected to an end of each of the short sides, wherein the rectangular frame defines a rectangular cavity, and at least two casters for moving along the ramp caster tracks, the ramp adapter caster tracks, and the rack caster tracks, and the second mounted winch connects to the third trolley via a second winch cable and pulls the third trolley and fourth trolley into the container.

5. The system of claim 4, wherein each of the first trolley, second trolley, third trolley, and fourth trolley comprise a rectangular trolley frame, one or more caster supports attached to the trolley frame, and at least one winch attachment point, wherein the at least two casters are attached to a bottom surface of the one or more caster supports and extend below the trolley frame.

6. The system of claim 4, wherein each of the first trolley and the third trolley further comprises one or more front bars, each of the one or more front bars having a first end connected substantially perpendicular to one of the two long sides of the rectangular frame and a second end extending out from the rectangular frame and substantially parallel to each of the short sides of the rectangular frame.

7. The system of claim 6, wherein each of the first winch mount assembly and second winch mount assembly further comprises one or more front bar deflectors.

8. The system of claim 3, further comprising a ramp winch, affixed to the ramp at a location proximate to the second end of the ramp and connectable to the second trolley via a ramp winch cable, wherein the ramp winch pulls the second trolley from the container.

9. The system of claim 1, further comprising a power source operative to apply electrical power to the first winch.

10. A method for loading a vehicle into the system of claim 1 comprising the steps of:
connecting the first trolley to the at least two ramp caster tracks at a first trolley loading point on the ramp;
connecting the second trolley to the at least two ramp caster tracks at a second trolley loading point on the ramp;
causing a first vehicle having a first end and a second end to be moved onto the ramp and placing wheels located on the first end of the first vehicle on each of the long sides of the rectangular frame of the first trolley and spanning the rectangular cavity of the first trolley, and wheels located on the second end of the first vehicle on each of the long sides of the rectangular frame of the second trolley and spanning the rectangular cavity of the second trolley;
connecting the first winch cable of the first mounted winch to the first trolley; and
pulling, by the first mounted winch, the first trolley into the container, causing the at least two casters of the first trolley to roll the length of the combination of the ramp caster tracks, the ramp adapter caster tracks, and the rack caster tracks, wherein pulling the first trolley causes the wheels of the first end of the first vehicle, secured to the first trolley, to move with the first trolley, which causes the second trolley to follow the first trolley as the second trolley is secured to the wheels of the second end of the first vehicle, causing the first vehicle to be moved from the ramp into the container.

11. The method of claim 10, wherein the rectangular frame of the first trolley further comprises one or more front bars, each of the one or more front bars having a first end connected substantially perpendicular to one of the two long sides of the rectangular frame of the first trolley and a second end extending out from the first trolley and substantially parallel to each of the short sides of the rectangular frame of the first trolley, wherein placing the wheels located on the first end of the first vehicle on the first trolley further comprises attaching one or more front bar tie-down chains to the one or more front bars at one end and to the first vehicle at the other end.

12. The method of claim 11, further comprising:
pulling the first trolley to the first winch mount assembly by the first mounted winch, wherein the one or more front bars contacts one or more front bar deflectors on the first winch mount assembly;
deflecting, by the one or more front bar deflectors, each of the one or more front bars connected to the first trolley downwards;
causing the first vehicle to be pulled downwards towards the floor by the one or more front bar tie-down chains attached to the deflected one or more front bars; and
attaching, via one or more rear tie-down ratchet straps, the second end of the first vehicle to the rack.

13. The method of claim 10, further comprising:
connecting a second winch mount assembly to the rack behind the first vehicle, wherein a second mounted winch is mounted to the second winch mount assembly;
connecting a third trolley, comprising at least two casters that are removably engaged with each of the rack caster tracks, the ramp caster tracks and the ramp adapter caster tracks and movable along the length extending a combination of the ramp caster tracks, the ramp adapter caster tracks, and the rack caster tracks, to the at least two ramp caster tracks at the first trolley loading point on the ramp;
connecting a fourth trolley, comprising at least two casters that are removably engaged with each of the rack caster tracks, the ramp caster tracks and the ramp adapter caster tracks and movable along the length extending a combination of the ramp caster tracks, the ramp adapter caster tracks, and the rack caster tracks to the at least two ramp caster tracks at a second trolley loading point on the ramp, wherein the third trolley and the fourth trolley each comprise a rectangular frame having two long sides and two short sides and each end of each of the long sides is connected to an end of each of the short sides, wherein the rectangular frame defines a rectangular cavity;
causing a second vehicle having a first end and a second end to be moved onto the ramp and placing wheels located on the first end of the second vehicle on each of the long sides of the rectangular frame of the third trolley and spanning the rectangular cavity of the third trolley, and wheels located on the second end of the second vehicle on each of the long sides of the rectangular frame of the fourth trolley and spanning the rectangular cavity of the fourth trolley;
connecting a second winch cable of the second mounted winch to the third trolley; and
pulling, by the second mounted winch, the third trolley into the container, causing the at least two casters of the third trolley to roll the length of the combination of the ramp caster tracks, the ramp adapter caster tracks, and the rack caster tracks, wherein pulling the third trolley causes the wheels of the first end of the second vehicle, secured to the third trolley, to move with the third trolley, which causes the fourth trolley to follow the third trolley as the fourth trolley is secured to the wheels of the second end of the second vehicle, causing the second vehicle to be moved from the ramp into the container.

14. The method of claim 13, further comprising:
securing the second vehicle to the second winch mount assembly;
attaching, via one or more rear tie-down ratchet straps, the second end of the second vehicle to the rack;
disconnecting the one or more ramp adapters from in between the ramp and the rack;
connecting a rear winch to the ramp via a rear winch cable, wherein the rear winch is affixed to the container; and
causing, by the rear winch, the second end of the ramp to fold into the opening of the container.

15. The method of claim 13, wherein the rectangular frame of the third trolley further comprises one or more front bars, each of the one or more front bars having a first end connected substantially perpendicular to one of the two long sides of the rectangular frame of the third trolley and a second end extending out from the third trolley and substantially parallel to each of the short sides of the rectangular frame of the third trolley, wherein placing the wheels located on the first end of the second vehicle onto the third trolley further comprises attaching one or more front bar tie-down chains to the one or more front bars at one end and to the second vehicle at the other end.

16. The method of claim 14, wherein securing the second vehicle to the second winch mount assembly further comprises:
pulling the third trolley to the second winch mount assembly by the second mounted winch, wherein the one or more front bars contacts one or more front bar deflectors on the second winch mount assembly;
deflecting, by the one or more front bar deflectors, each of the one or more front bars connected to the third trolley downwards; and
causing the second vehicle to be pulled downwards towards the floor by the one or more front bar tie-down chains attached to the deflected one or more front bars.

17. The method of claim 13, further comprising:
removing the one or more rear tie-down straps connecting the second vehicle to the rack;
connecting a ramp winch affixed to the ramp at a position proximate to the second end of the ramp to the fourth trolley via a ramp winch cable;
causing the ramp winch to remove the second vehicle from the container by pulling the fourth trolley out of the container and onto the ramp, wherein pulling the fourth trolley causes the at least two casters of the fourth trolley to roll along the length of the combination of the rack caster tracks, the ramp adapter caster tracks, and ramp caster tracks, causing the third trolley to follow the fourth trolley as the second vehicle connects the third trolley to the fourth trolley;
connecting the third trolley to a first trolley loading point on the ramp;
connecting the fourth trolley to a second trolley loading point on the ramp;
disconnecting the ramp winch cord from the fourth trolley;
releasing the wheels at the first end of the second vehicle from the third trolley;
releasing the wheels at the second end of the second vehicle from the fourth trolley; and
causing the second vehicle to be moved down off of the ramp.

18. The method of claim 17, further comprising:
removing the fourth trolley from the second trolley loading point and the third trolley from the first trolley loading point; and
removing the second winch mount assembly from the rack.

19. The method of claim 10, further comprising:
connecting a ramp winch affixed to the ramp to the second trolley via a ramp winch cable;
causing the ramp winch to remove the first vehicle from the container by pulling the second trolley out of the container and onto the ramp;
connecting the first trolley to a first trolley loading point on the ramp, wherein pulling the second trolley causes the at least two casters of the second trolley to roll along the length of the combination of the rack caster tracks, the ramp adapter caster tracks, and ramp caster tracks, causing the first trolley to follow the second trolley as the first vehicle connects the first trolley to the second trolley;
connecting the second trolley to a second trolley loading point on the ramp;
disconnecting the ramp winch cord from the second trolley;
releasing the wheels at the first end of the first vehicle from the first trolley;
releasing the wheels at the second end of the first vehicle from the second trolley; and
causing the first vehicle to be moved down off of the ramp.

20. The method of claim 19, wherein each of the first mounted winch, the second mounted winch, and the ramp winch are connected to a power source.
